(19) United States
(12) Patent Application Publication
(10) Pub. No.: US 2019/0220157 A1
(43) Pub. Date: Jul. 18, 2019

(54) METHOD AND SYSTEM FOR GRAPH DATA MANAGEMENT

(71) Applicant: NOT FOR PROFIT STRATEGIC PLANNING LLC, San Rafael, CA (US)

(72) Inventor: EDWARD P. CROUCH, San Rafael, CA (US)

(21) Appl. No.: 16/250,387

(22) Filed: Jan. 17, 2019

Related U.S. Application Data
(60) Provisional application No. 62/618,404, filed on Jan. 17, 2018.

(51) Int. Cl. G06F 3/0484; G06F 16/22; G06F 9/451; G06F 16/23; G06F 17/24

(52) U.S. Cl. CPC G06F 3/0484; G06F 16/2237; G06F 17/246; G06F 16/2379; G06F 9/453

(57) ABSTRACT

A system and method for data management including a dynamic user interface on a graph-based data model to regenerate and statically update data in an array and the graphical representation of array data. The system can provide a basis for a wide range of data management applications, such as for data modeling, route guidance, financial and production modeling, and user interactivity in data manipulation.

### CROSS-REFERENCE TO RELATED APPLICATIONS

This application is a non-provisional of, and claims priority to, U.S. Provisional Application Ser. No. 62/618,404, filed Jan. 17, 2018, which application is hereby incorporated by reference in its entirety and for all purposes.

### FIELD

The present disclosure relates to data modeling, and more specifically, but not exclusively, to a system and method for graph data management and array updates and the presentation of a user interface for managing the same.

### BACKGROUND

Conventional organization, analysis, and storage of data can include various forms, such as through an electronic spreadsheet, or database array. Each of these forms is an interactive computer application that operates on data entered, often in cells of a table. Each cell can include numeric data, text data, or formulaic data that automatically calculates and displays a value based on the cell's own contents or values of other related cells or data elements.

Many spreadsheet and database applications permit charts, graphs, histograms, or other graphical representation of the data to be generated from specified groups of cells or data elements that can be dynamically re-built as cell contents or data elements change. The graphical representation generated from the data array component can be displayed independently of the database's user input interface, embedded within a spreadsheet tab, or added as a separate object elsewhere within the current (or another) database or spreadsheet.

Database array, spreadsheet, and other tabular data users can often adjust values stored in a cell and observe the effects on calculated values of other cells. However, if the database array or spreadsheet was represented in graphical form, the entire graph must be regenerated after any values in the database array or spreadsheet are adjusted.

A shortcoming of the conventional processes described above is that in order to represent new data in graphical form, the user must enter new data into the data array or spreadsheet and then generate a new graph instead of directly manipulating the existing graph to generate new data in the database array.

In view of the foregoing, a need exists for an improved system for data management in an effort to overcome the aforementioned obstacles and deficiencies of conventional data organization, analysis, and storage systems.

### BRIEF DESCRIPTION OF THE DRAWINGS

FIG. 1 is an exemplary top-level block diagram illustrating one embodiment of a data management system for managing array data.

FIG. 2A is an exemplary top-level functional flow diagram illustrating one embodiment of a process for updating a data array using graph user interface of the data management system of FIG. 1.

FIG. 2B is an exemplary screenshot illustrating one embodiment of exemplary graph user interfaces of FIG. 1.

FIG. 2C is an exemplary screenshot illustrating one embodiment of the graph user interface of FIG. 2B after the data arrays are updated using the process of FIG. 2A.

FIG. 2D is an exemplary screenshot illustrating another embodiment of an exemplary graph user interface of FIG. 1.

FIG. 2E is an exemplary screenshot illustrating another embodiment of the exemplary graph user interface of FIG. 2D.

FIG. 2F is an exemplary screenshot illustrating another embodiment of the graph user interface of FIG. 2D.

FIG. 3A is an exemplary screenshot illustrating another embodiment of an exemplary graph user interface of FIG. 1.

FIG. 3B is an exemplary screenshot illustrating one embodiment of the corresponding data array user interface of the graph user interface of FIG. 2B after the data arrays are updated using the process of FIG. 2A.

FIG. 4 is an exemplary screenshot illustrating another embodiment of exemplary graph user interfaces of FIG. 1.

FIG. 5 is an exemplary top-level functional flow diagram illustrating another embodiment of a process for updating a data array using the data array user interface of the data management system of FIG. 1.

FIG. 6A is an exemplary screenshot illustrating one embodiment of an exemplary data array user interface of FIG. 1.

FIG. 6B is an exemplary screenshot illustrating one embodiment of the data array user interface of FIG. 6A after the data arrays are updated using the process of FIG. 5.

FIG. 6C is an exemplary screenshot illustrating another embodiment of the exemplary data array user interface of FIG. 1.

FIG. 6D is an exemplary screenshot illustrating one embodiment of the data array user interface of FIG. 6C being transformed using the process of FIG. 5.

FIG. 6E is an exemplary screenshot illustrating another embodiment of the data array user interface of FIG. 6C being transformed using the process of FIG. 5.

FIG. 7 is an exemplary screenshot illustrating another embodiment of an exemplary data array user interface of FIG. 1.

FIG. 8A is an exemplary top-level functional block diagram illustrating one embodiment of the data flow for managing the data using the data management system of FIG. 1.

FIG. 8B is an exemplary screenshot illustrating one embodiment of an exemplary data array user interface for use with the functional flow diagram of FIG. 8A.

FIG. 8C is an exemplary screenshot illustrating another embodiment of an exemplary data array user interface for use with the functional flow diagram of FIG. 8A.

FIG. 8D is an exemplary screenshot illustrating another embodiment of an exemplary data array user interface for use with the functional flow diagram of FIG. 8A.

FIG. 8E is an exemplary screenshot illustrating another embodiment of an exemplary data array user interface for use with the functional flow diagram of FIG. 8A.

FIG. 8F is an exemplary screenshot illustrating one embodiment of an exemplary graph user interface for use with the functional flow diagram of FIG. 8A.

FIG. 9A is an exemplary top-level functional flow diagram illustrating another embodiment of a process for managing the data created by the data management system of FIG. 1.

FIG. 9B is an exemplary screenshot illustrating one embodiment of an exemplary data array user interface for use with the process of FIG. 9A.

FIG. 9C is an exemplary screenshot illustrating another embodiment of an exemplary data array user interface for use with the process of FIG. 9A.

FIG. 9D is an exemplary screenshot illustrating another embodiment of an exemplary data array user interface for use with the process of FIG. 9A.

FIG. 9E is an exemplary screenshot illustrating another embodiment of an exemplary data array user interface for use with the process of FIG. 9A.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

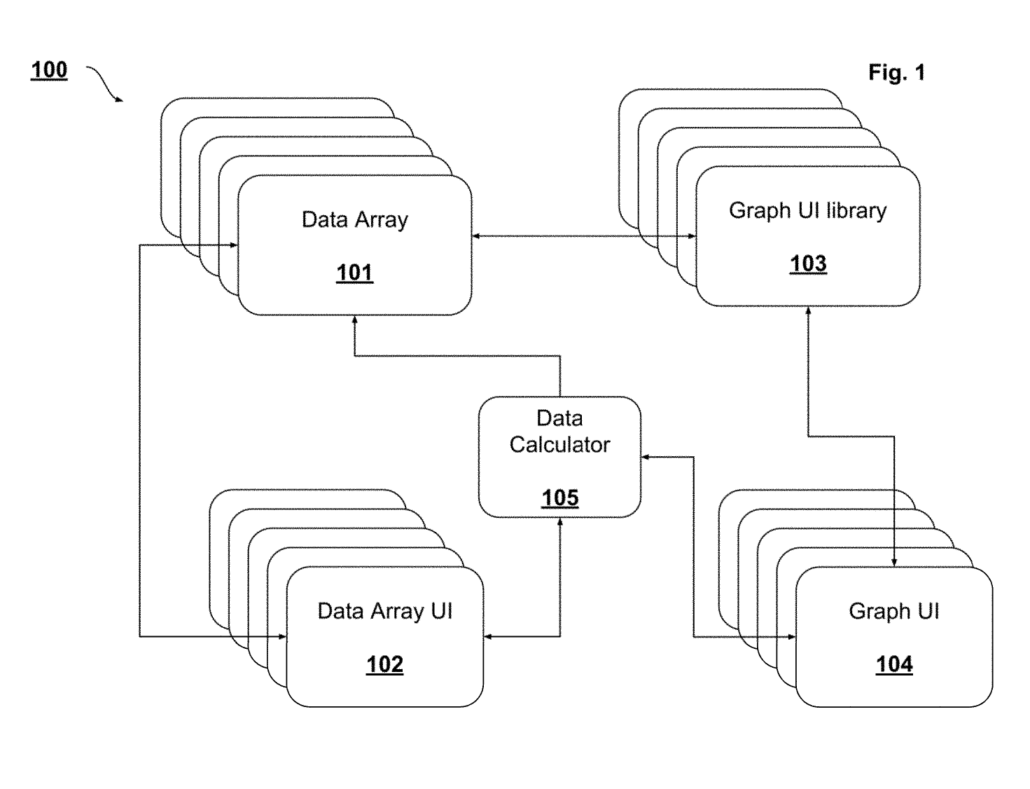

Since currently-available data management systems are deficient because of the need to regenerate and statically update a graphical representation of array data by inputting new values into the database array, spreadsheet, and other tabular data (collectively “database array”), a system for data management including a dynamic user interface on a graph-based data model can prove desirable and provide a basis for a wide range of data management applications, such as for data modeling, route guidance, financial and production modeling, and user interactivity in data manipulation. This result can be achieved, according to one embodiment disclosed herein, by a data management system 100 as illustrated in FIG. 1.

Turning to FIG. 1, data management system 100 advantageously provides both a data array user interface (UI) 102 and a graph user interface (graph UI) 104 for modifying a data array 101. The data array UI 102 can also be referred to as a cell-based user interface.

As shown, the data management system supports any number of data array UIs 102 and any number of graph UIs 104 (which graph UIs 104 cooperate with one or more graph UI libraries 103) for operating on one or more data arrays 101. Those of ordinary skill in the art will appreciate that a selected data array UI 102 and a selected graph UI 104 (with an associated graph UI library 103) can be associated with a single data array 101. Additionally and/or alternatively, one or more data array UIs 102 and one or more graph array UIs 104 can be associated with a single data array 101. In some embodiments, one or more data array UIs 102 and one or more graph array UIs 104 can be associated with a plurality of data arrays 101. Stated in another way, there can be a one-to-one mapping between a data array 101 and its corresponding data array UI 102 and graph UI 104; and/or there can be a one-to-many association between data arrays 101 and data array UIs 102/graph UIs 104, as desired.

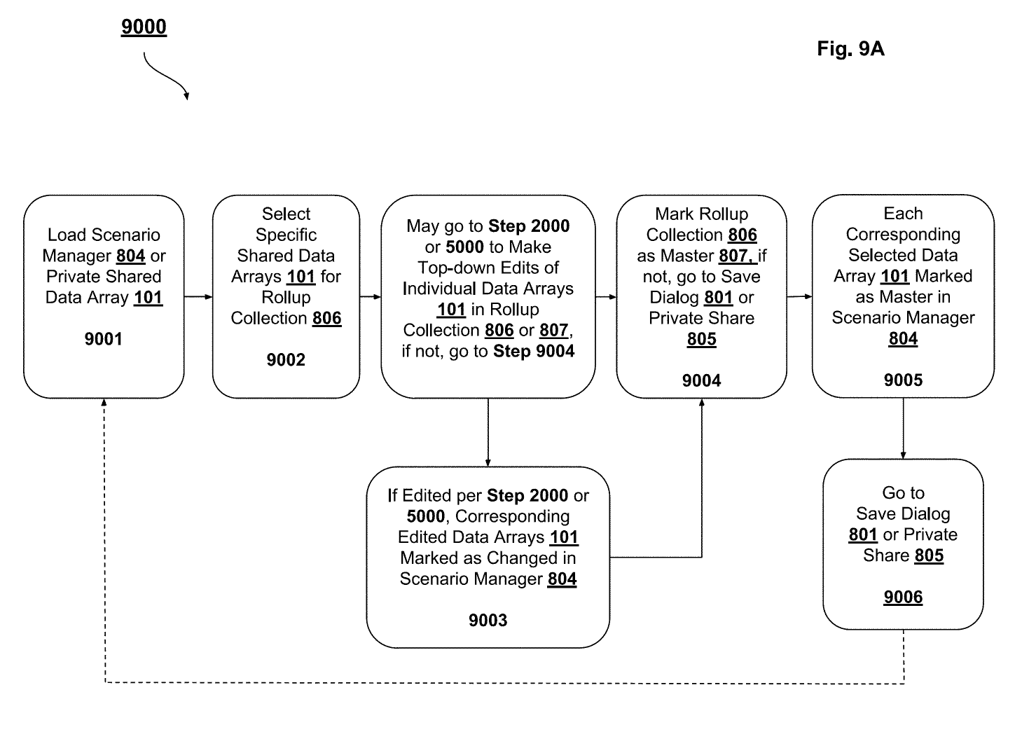

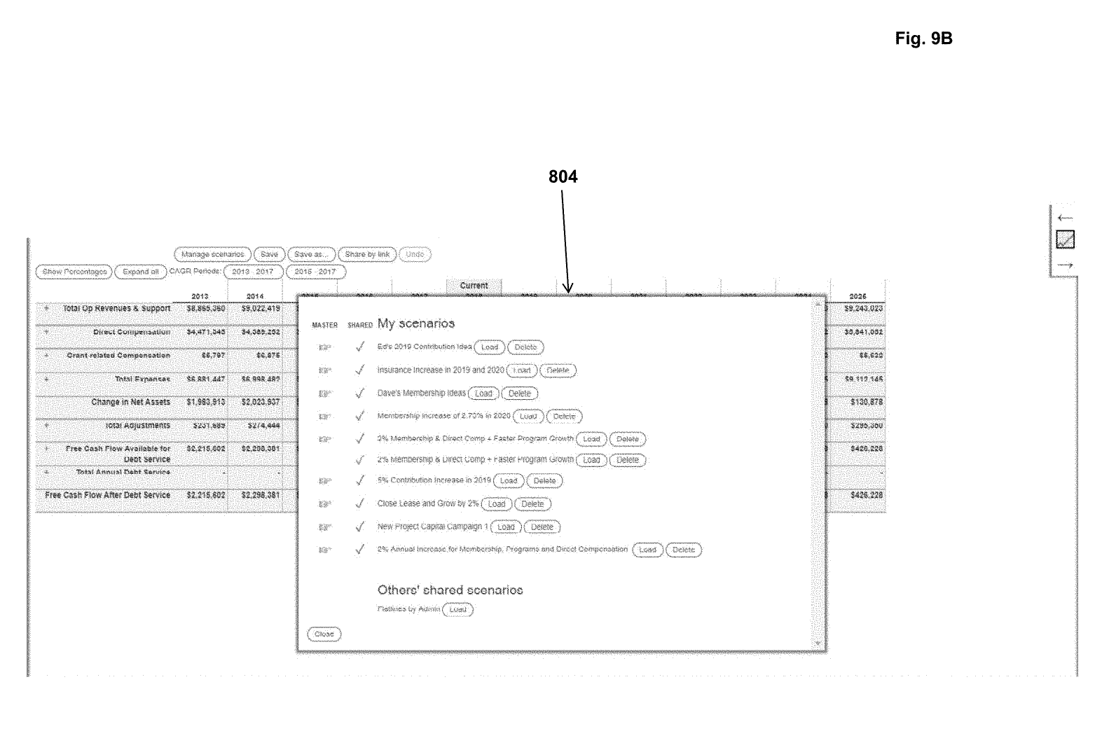

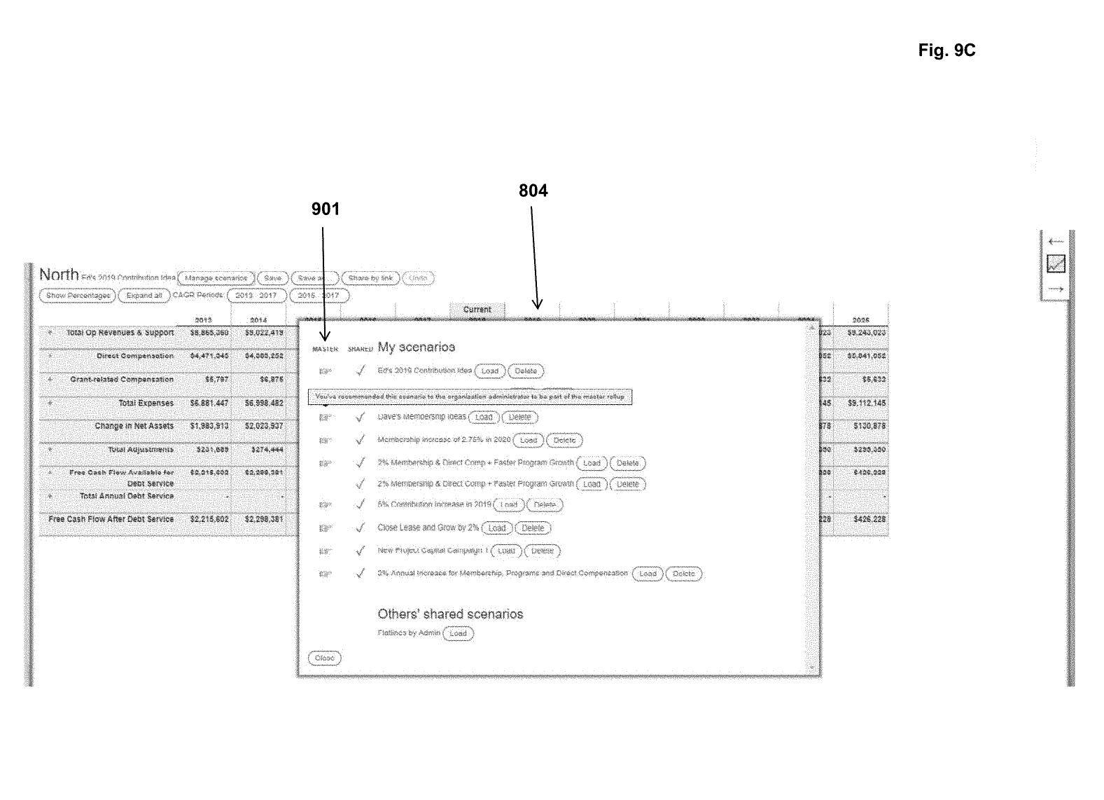

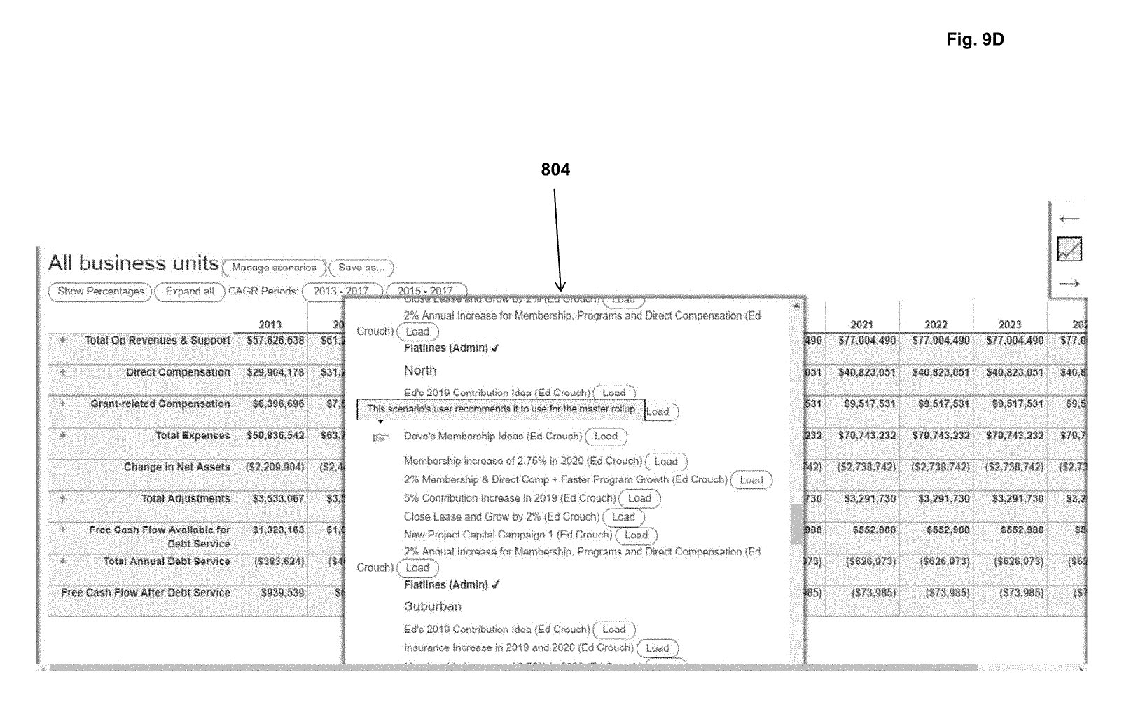

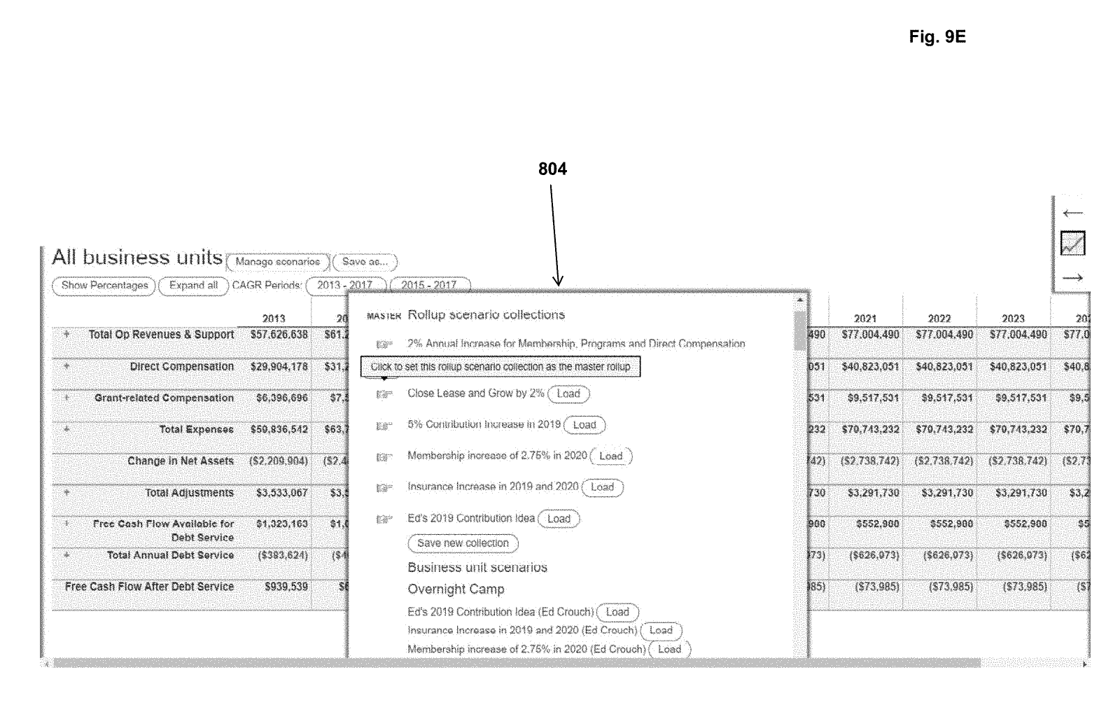

In some embodiments and as further described herein with reference to FIGS. 9A-E, groups of one or more data arrays 101, one or more data array UIs 102, one or more graph UI libraries 103, and one or more graph UIs 104 can be compiled such that their associated data (e.g., text, numerical, and graph data) are combined.

A selected data array 101 can include a structured data model that comprises the information required to present data visible via the data array UI 102 and the graph UI 104, as well as information required by a graph UI library 103 and a data calculator 105. In some embodiments, the data array 101 receives data from the data calculator 105 and communicates with the data array UI 102 and the graph UI library 103 when the data array 101 is updated. Additionally and/or alternatively, the data array 101 can receive data directly from the graph UI library 103 and communicate with the data array UI 102 and the graph UI library 103 when the data array 101 is updated.

The data array 101 can be structured as a dictionary. By way of example, the data array 101 can be implemented using Python and Swift as a dictionary. Similarly, the data array 101 can be represented as one or more objects in JavaScript. In either example, the data array 101 can be represented by key-value pairs.

Each key in the data array 101 corresponds to an identification (ID) for a value or calculation line for a selected data array 101. Each value in the data array 101 includes another dictionary where a key of the dictionary corresponds to the ID for an x-y axis intersection of the selected data array 101.

This two-dimensional structure (i.e., a dictionary embedded within a dictionary) corresponds to the two-dimensional structure that is visible via the data array UI 102 and the graph UI 104, where each x- and y-axis object value (also referred to as a “data array cell”) corresponds to a respective “cell” in the relevant data array UI 102 and the graph UI 104.

In some embodiments, the value for this embedded dictionary is yet another dictionary where the key can be predetermined (hardcoded) and/or configured by the data management system 100 as one of the following:

“amount”—for which the value is a number object that will be represented as the amount in the corresponding cell of the data array UI 102, and used by the data calculator 105 for updates.

“calculated”—for which the value is a number object that will be represented as the percentage in the corresponding cell of the data array UI 102, and used by the data calculator 105 for updates.

“modified”—for which the value is a boolean indicating whether the corresponding cell of the data array UI 102 ought to be visually highlighted by virtue of it having changed as a result of an edit to the data array UI 102 or the graph UI 104.

“futures Workspace”—used for combining select groups of the data array 101 and for which the value is a dictionary where the key corresponds to a particular ID of the data array 101, and the value is a dictionary which contains “amount” and “calculated” keys where the respective values (amounts and percentages for the corresponding data array 101) are used by the data calculator 105 for updating cell level amounts and percentages.

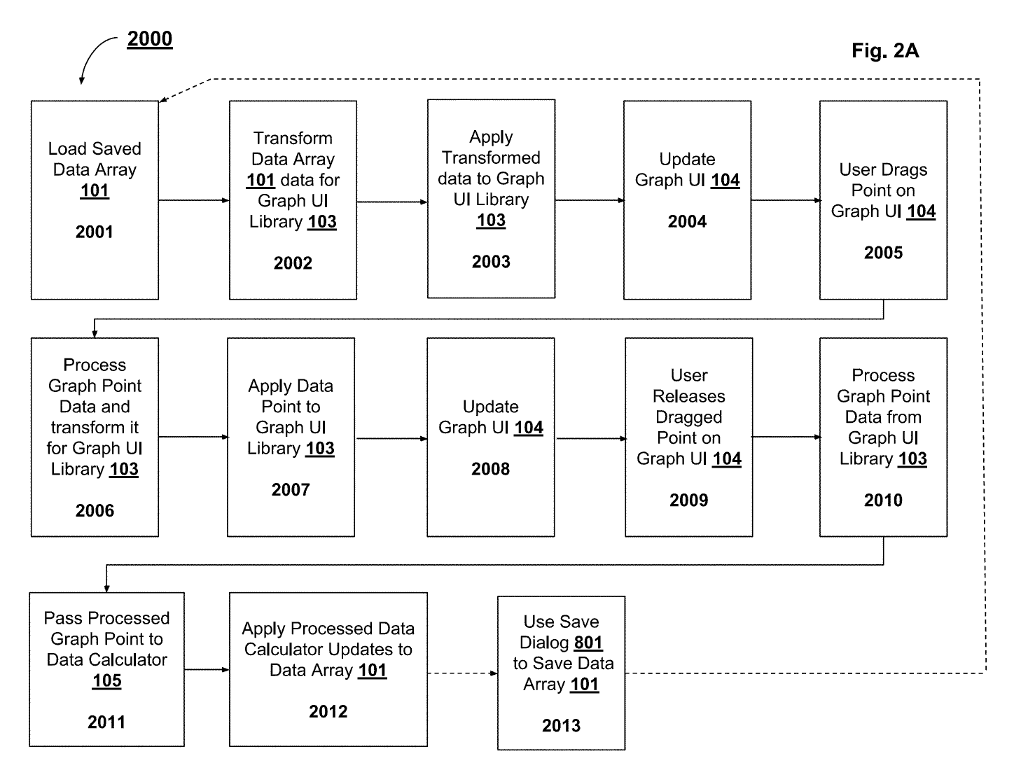

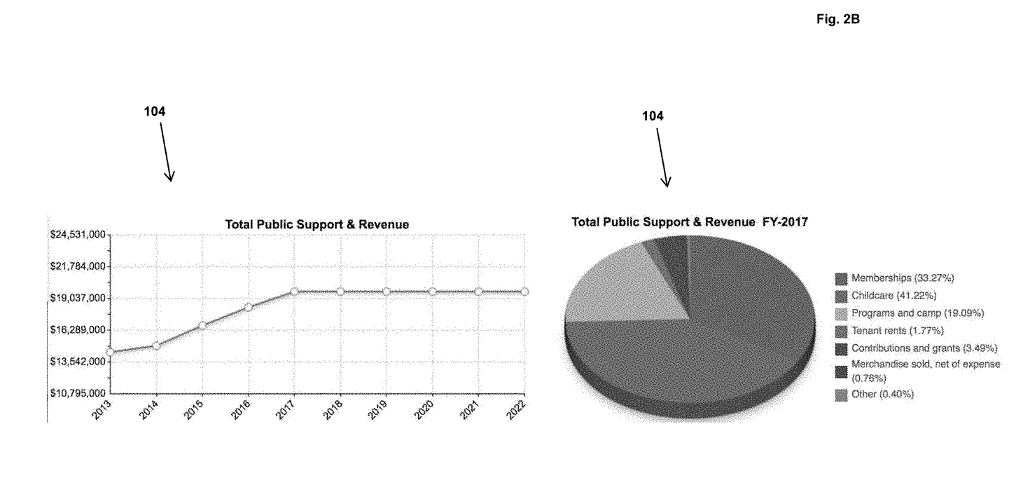

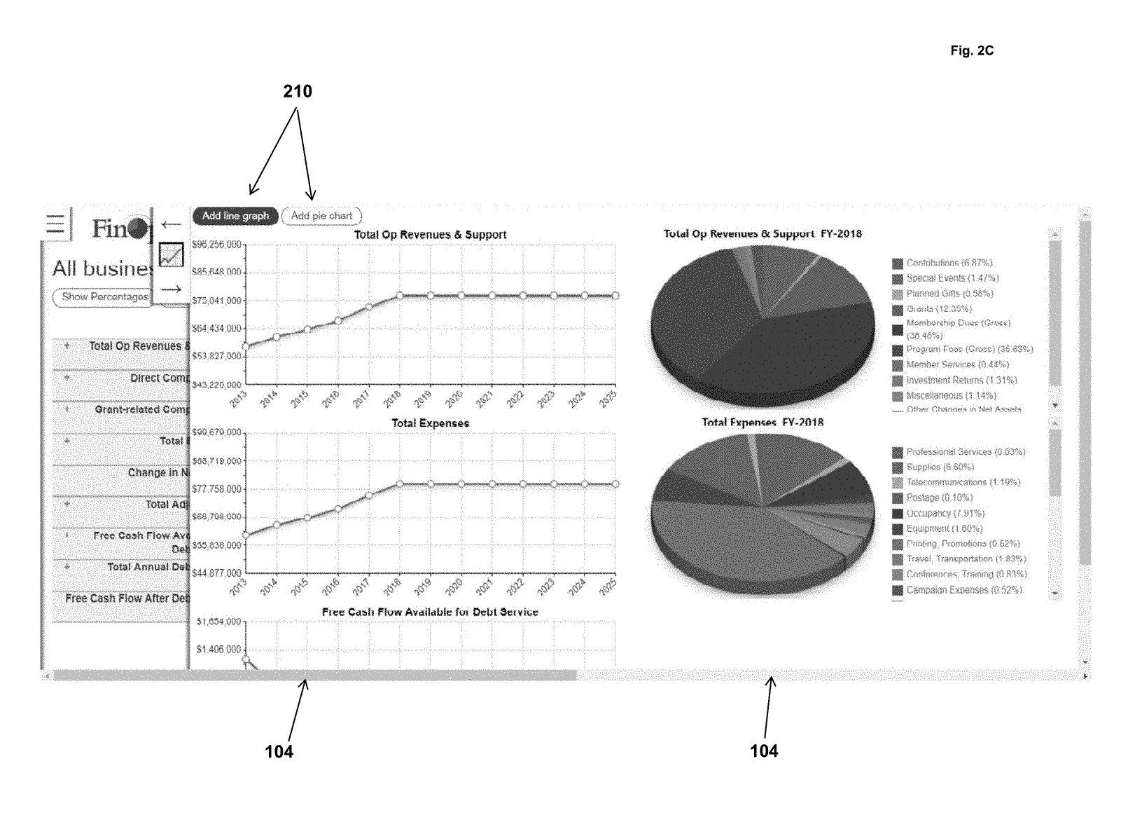

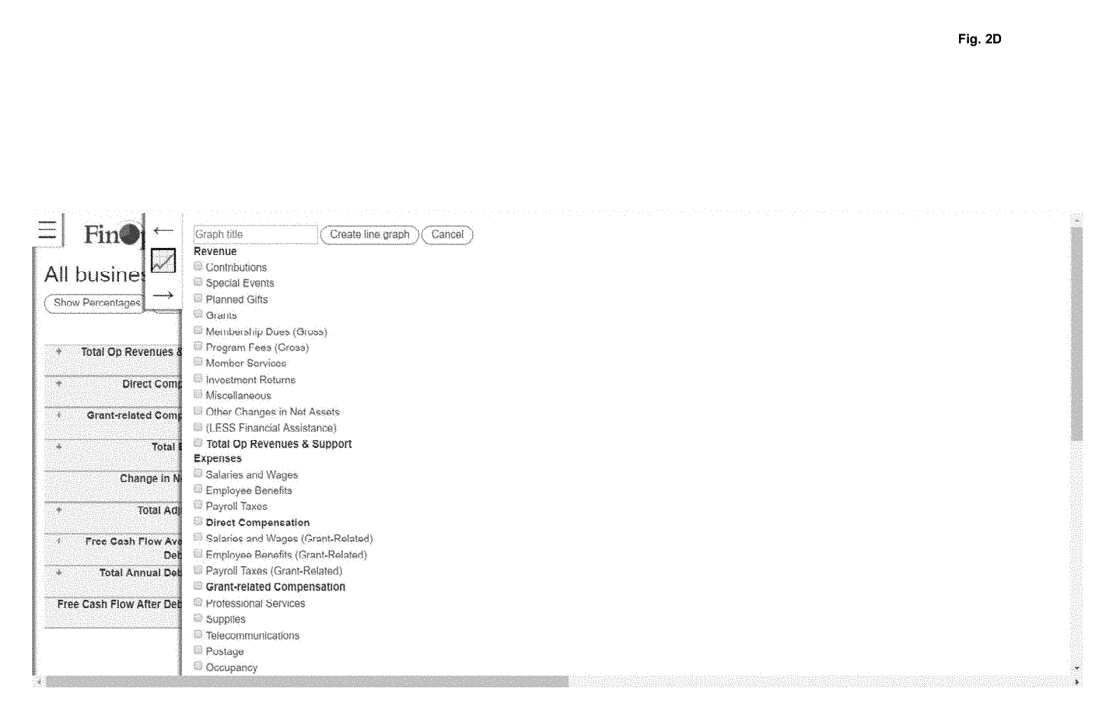

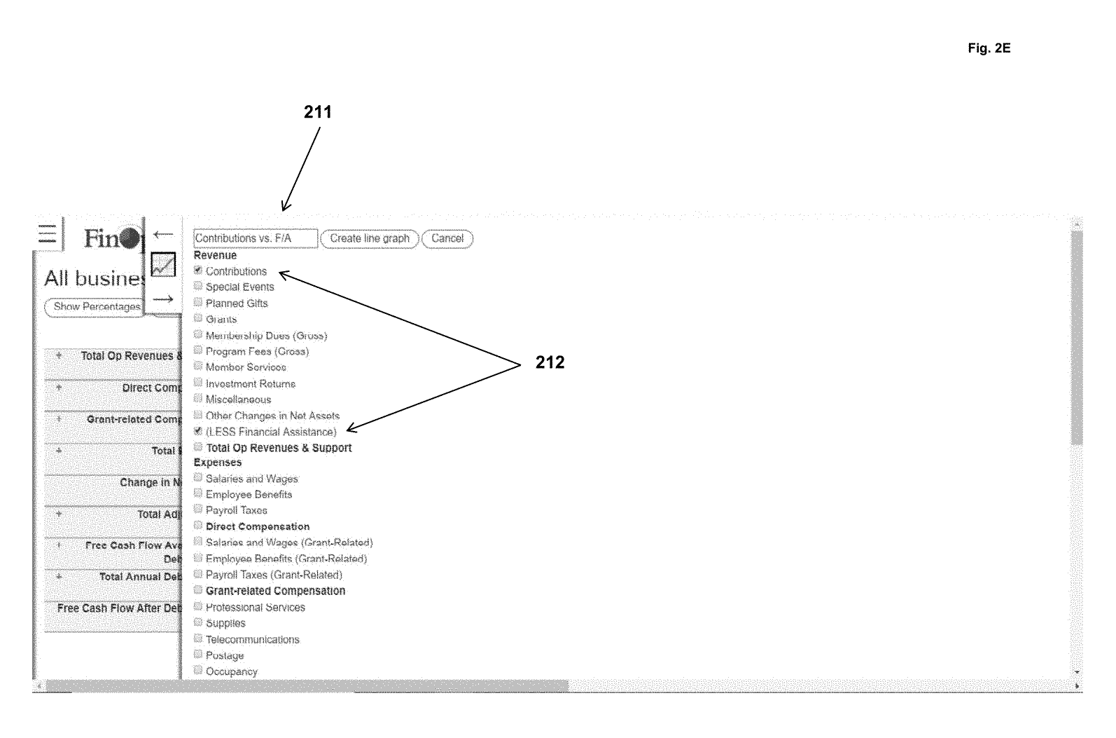

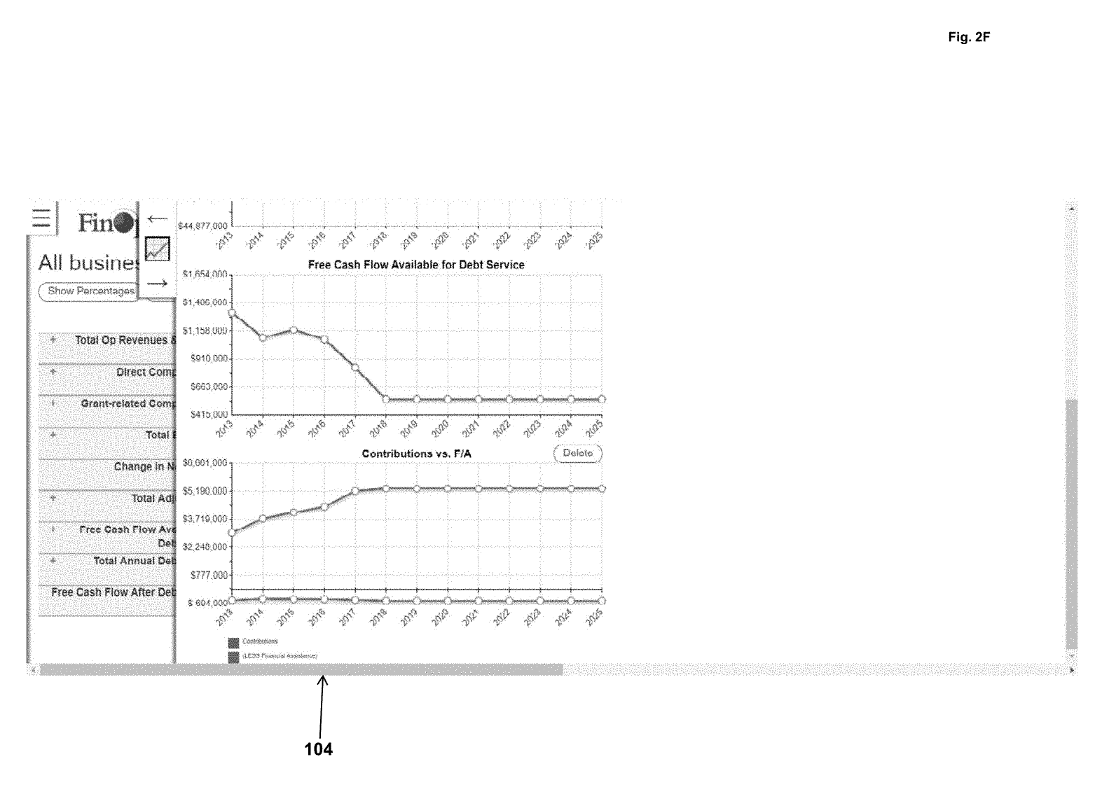

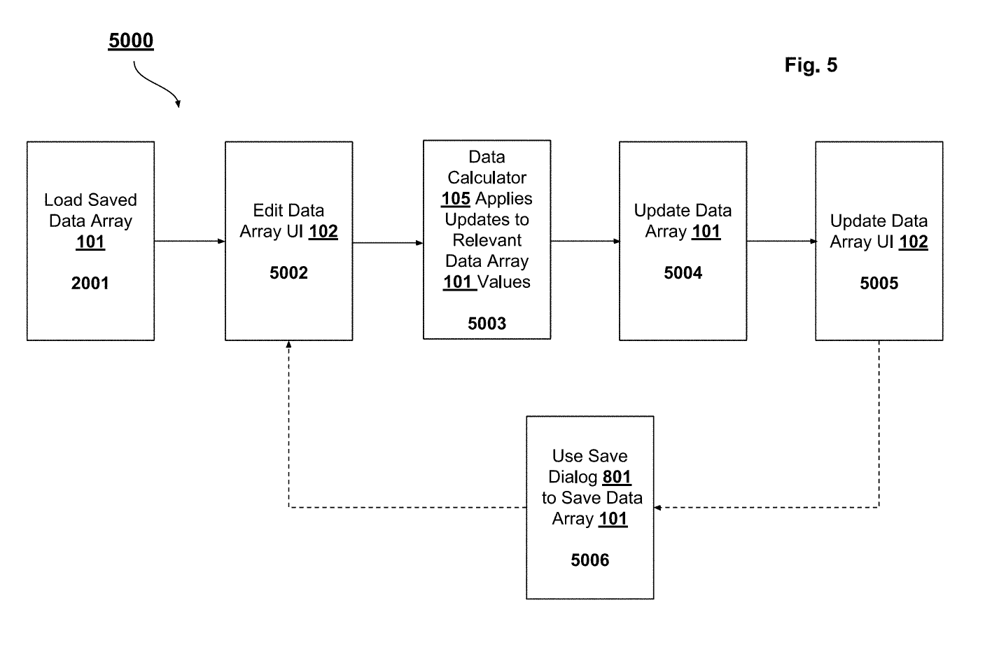

As also shown in FIG. 1, the data calculator 105 operates on the data array 101 when any portion of the data is updated. Updates can occur in any manner described herein, such as through a modification of a cell through a user interface (e.g., exemplary processes 2000 and 5000, shown in FIGS. 2A and 5, respectively), through a scenario loaded into collection for rollup, and/or through an initial set-up.

When a modification of a cell occurs through a user interface, the data calculator can receive value updates for a particular cell of the data array 101 from the data array UI 102 and/or the graph UI 104. The calculation varies depending on the type of the cell changed and whether the loaded workspace represents a single unit or a rollup.

For example, when the value of a cell is changed via user interface, the data in the corresponding cell of the data array 101 and any associated cells are updated. Additionally and/or alternatively, all sum cells that include any changed data will also be updated. Although referenced as a “sum cell,” those of ordinary skill in the art will appreciate that any numerical operation can be applied to selected data and not only a summation or addition. In the case of an “amount” change, the “amount” field for the cell of the data array 101 corresponding to the user interface is updated. The “calculated” field is also updated. In the case of a percentage change, the “calculated” field for the corresponding cell of the data array 101 will be updated to the percentage while the “amount” field is also updated to reflect the new percentage. For each remaining cell of the data array 101, the “amount” field is updated so the percentage field is mathematically accurate (e.g., totals one hundred percent). For sum cells, both the “amount” and “calculated” field are updated.

By way of another example, when a sum value is changed, every value cell that the sum encompasses is updated. In some embodiments, each corresponding cell of the data array 101 is changed to a prorated amount determined by the difference between the original value of the sum cell and its updated value. The changes carry over to remaining cells of the data array 101 and other data array cells as described herein.

When a value cell is changed in a rollup, the “amount” field is updated for the corresponding cell of the data array 101 in the “futures Workspace” and prorated based on the difference between the new and original value. Every following value cell and corresponding sum cell (in the “futures Workspace”) is updated, the updated values added to determine an “amount” and “percentage” of the data array cell. When a sum value is changed in a rollup, every value cell that the sum cell encompasses is updated.

In a rollup screen, scenarios can be independently loaded to create a real-time rollup where each entry of the data array 101 is the sum of all respective data. For this case, when a selected scenario is loaded, the data calculator 105 updates the “futures Workspace” entry for every cell of the data array 101, and iterates through a rollup applying calculations for all value cells.

For an initial set-up, the underlying set-up data that results in a selected scenario can be updated. The data calculator 105 can load the updated set-up data into corresponding portions of the data array 101. In some embodiments, the “amounts” field for each cell of the data array 101 can be updated. In some embodiments, the “futures Workspace” field in each cell of the data array 101 can be updated. Calculations reflect multiple cell updates compared to a single cell update.

As described above, the data calculator 105 operates on the data array 101 when any portion of the data is updated. Updates can occur in any manner described herein, such as through an exemplary process 2000 for modification of a cell of the data array 101 through a graph user interface 104, which process 2000 is shown in FIG. 2A. In one embodiment, graphs can be created on-demand through the graph UI 104. Similarly, data arrays can be created on-demand through the data array UI 102. Stated in another way, data grid changes to the data array UI 102 and/or graph UI 104 can cause on demand updates to the data array 101, thereby dynamically updating both the graph UI 104 and the data array UI 102. In some embodiments, when edits are made to the data array UI 102, the graph UI 104 is prepared and saved through the use of the graph UI library 103.

In some embodiments, the graph UI library 103 can include a JavaScript library, such as React, ReactJS, and/or RGraph, for building user interfaces. The graph UI library 103 can parse each data array 101 (e.g., the data array UI 102 and the graph UI 104) to display information in any format, including Hypertext Markup Language (HTML). For example, the data calculator 105 can extract the information from the data array 101 into a format usable by the graph UI library 103. The graph UI 104 can dynamically detect changes to each data array 101 and update relevant user interfaces.

Turning to FIG. 2A, once the data array 101 is loaded (at step 2001), the selected data array 101 is transformed into a format compatible with the selected graph UI library 103 (step 2002), and passed to the graph UI library 103 (step 2003). As an example, the graph data from the graph UI 104 can be transformed to a related data array UI 102 through the data calculator 105. In some embodiments, this includes picking out raw numbers and labels relevant for the graph and arranging them in appropriate structures of the data array 101. In some embodiments, this includes determining the values for relevant rows and columns from the graph UI 104 as well as any corresponding labels.

Next, at step 2004, the graph UI library 103 updates the graph UI 104 at which time a user may edit data by dragging a point on the graph UI 104 (step 2005). In step 2006, the data management system 100 processes the edited graph point data and transforms the coordinates for the graph UI library 103. At step 2007, the point data is applied to the graph UI library 103, and the graph UI 104 is updated (step 2008). If satisfied with the results displayed on the graph UI 104, the point on the graph UI 104 is released (step 2009) and the graph point data is processed by the graph UI library 103 (step 2010). In step 2011, the processed graph point data is passed to the data calculator 105, which processed data from the data calculator 105 is applied to the data array 101 (step 2012). In step 2013, the data management system 100 enables users to save edited graph data using a save dialog 801 described in more detail below. Saved data arrays 101 are then available to be loaded at step 2001 for further analysis and modifications.

The process 2000 can operate on any number of data arrays 101. For example, the data array 101 can be presented graphically through the graph UI 104, such as shown in FIG. 2B. Those of ordinary skill in the art will appreciate that the methods described herein can be implemented to reflect the data array 101 having any number of graphs including multi-line graphs, bar graphs, scatter plots, pie charts, and so on.

FIGS. 2C through 2F illustrate an exemplary selection of data sets that are accessed from the graph UI library 103 for use with the update process 2000 of FIG. 2A. For example, FIG. 2C illustrates the creation of a new line graph using a new graph tooltip 210. FIG. 2D illustrates the various options for creating the graph UI 104 being displayed for analysis and editing based on the selection made in FIG. 2C. Turning to FIG. 2E, data sets 212 (e.g., line items) are selected, and users can name the graph using free text 211. The resulting new line graph based on the assigned name (selected through the free text 211) and labels (based on the data sets 212) is shown in FIG. 2F.

The graph UI library 103 updates the graph UI 104 along with formatting options and functions at step 2004. In some embodiments, formatting options include the arrangement of the graph and the axes. For example, the axes can be spaced, formatted, and angled to any predetermined specification. In one embodiment, the minimum and maximum graph values are 25% above and below the highest and lowest data values, respectively. The spread between minimum and maximum graph values can be established at any desired amount to produce graphs that the user finds desirable. Other formatting options and functions include line coloring, title placement, key placement, selecting graph style (e.g., line graph, pie chart, vertical or horizontal bar chart, stacked bar chart, histogram, scatter plot, area chart, bubble chart, funnel chart, bullet chart, heat map, box plot, etc.).

When generating a graph in the graph UI 104 as shown in FIGS. 2C through 2F, the values for relevant rows and columns (used for step 2006) as well as labels for those rows and columns are determined (e.g., used for updating the graph UI 104 in step 2007). The values for the relevant rows and columns and any labels used to populate an array can be used to generate the graph UI 104 (step 2008).

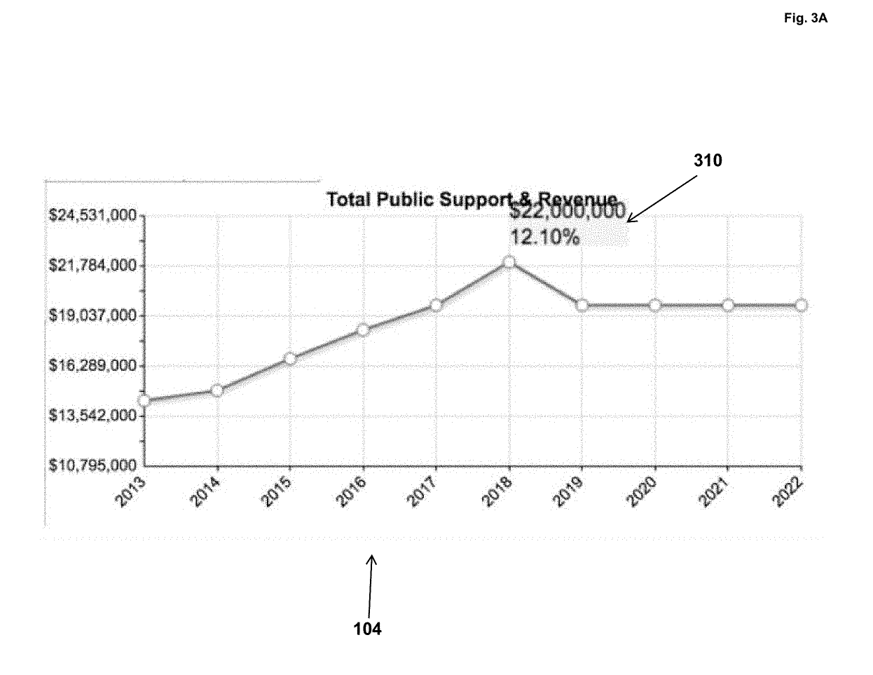

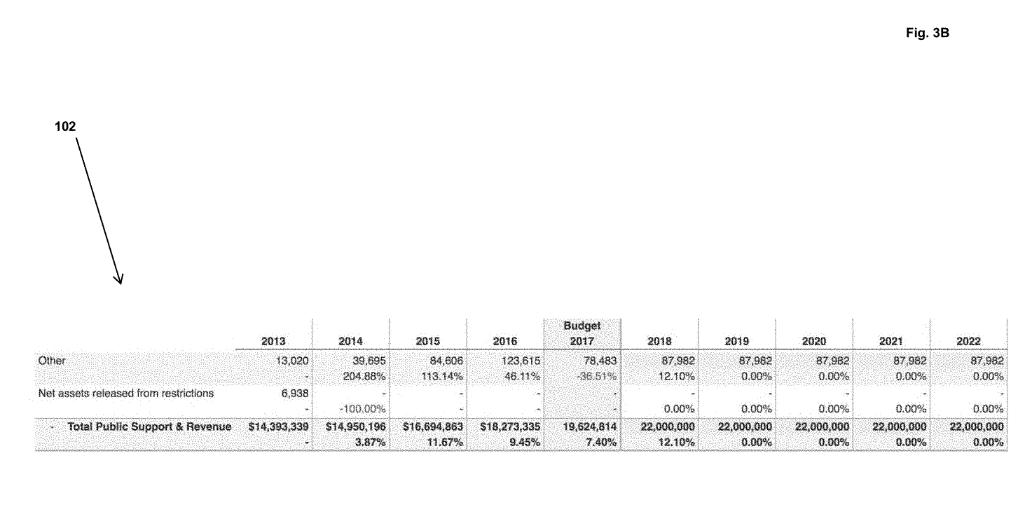

In some embodiments, a tooltip (such as a tooltip 310 as shown in FIG. 3A) appears as the point is dragged (at step 2005). As the point is being dragged, and once the point is released (step 2009), the updated value can be assessed and examined as a visual representation of the graphic output by edits to the data array 101 contemporaneously as the graph is being adjusted, and further in numerical form as a result of the data array being updated by the manipulation of the graph (e.g., rounded to a useful amount). In some embodiments, the updated value is structured as a point object from the graph UI library 103. In one embodiment, the value and index (i.e., the row and column the selected point corresponds to) of selected points are extracted from the updated value (step 2006). The value can be formatted into a desirable format, such as, including commas, symbols, and rounded values. In the example shown in FIG. 3A, a percentage change, or other useful calculation to establish the relative value of the selected amount compared with a previously established amount (i.e., same row, previous column) can also be calculated and displayed. This advantageously provides the user with a relative change of a selected data point to a second data point. Those of skill in the art will understand that the tooltip data can be displayed elsewhere on the graph UI 104, and can include any desired information for analyzing data points (e.g., text, amount, relative value, other identifying information). The updated value is then formatted for the graph UI library 103 (step 2007) which in turn updates the graph UI 104 (step 2008) to reflect the new value (shown in FIG. 3A).

In a preferred embodiment, the data management system 100 cooperates with user interactions with the graph UI 104 as described herein such that the change not only affects the graph UI 104, but also the data array UI 102 via the underlying data array 101. For example, when a user finishes dragging a point on a line graph to finalize a new value (step 2009), the point of release is processed from the graph UI library 103 (step 2010), and passed to the data calculator 105 (at step 2011) which converts the value from the structure defined by the graph UI library 103 to a predetermined structure (which includes coordinates for the grid cell) and rounds the value to reflect the user's desired requirements (step 2012). For example, the predetermined structure can include a multi-dimensional object that is keyed by the associated keys of the database. In one embodiment, a row key can be used as a first dimension, a column key can be used as a second dimension, and so on. A label assigned by the graph UI library 103 associates the graph with a third-dimension unique data array 101. An example graph UI 104 where a user has modified a value directly on the graph is shown in FIG. 3A.

As shown in FIG. 3A, the value for the year 2018 can be dragged up to produce a new value of $22 million calculated to be 12.10% greater than the value in the year 2017. The new graph generated value is passed to the data calculator 105 (at step 2011) that applies calculation updates for the respective cell and any dependent cells (at step 2012). In this example, when the point is dragged on the graph UI 104 (step 2005), a callback function within the graph UI library 103 determines (at step 2010) the column and line that has been modified. The graph UI library 103 callback function can also receive coordinates of where a user click occurred (step 2005), raw numerical values, and the index of a line and column (at step 2009). The callback function uses these index values and locates the corresponding row and column key for the selected point using the ID that maps the index to the keys discussed above. The new modified and formatted value and calculated percentage is accepted once the user releases a data point (step 2009).

Accordingly, the data array 101 is updated for one or more data array groups. As described above, this will also update relevant graph UI 104 (step 2009), graph UI library 103 (step 2010), data calculator 105 (step 2011), data array 101 (step 2012), and data array UI 102 (process 5000) since other cells may have new values (see FIG. 3B). One embodiment of the revised data array UI 102 corresponding to the change in FIG. 3A is shown in FIG. 3B. The data array UI 102 depicted in FIG. 3B also highlights rows and columns that have been affected by the user's interaction with the graph UI 104.

This highlighting function can prove useful to the user for keeping track of edits because of its simplicity and visual nature. While users have long had a visual way to create graphs from data and see data in the form of graphs, they've not been able to create data from graphs. Instead, users have undertaken the arduous task of interacting with a data array followed by the creation of the graph because of the lack of a graphical (visual) manner to manipulate the underlying data. The data management system 100 not only provides a quick and easy way to work with data, but also makes the task of working with data (especially in vast amounts displayed in a large array) accessible to those that are apprehensive about working in the numbers only environment of a grid of numbers.

In addition to the graph UI 104 described above, the data can be presented to the user through one or more data array UIs 102, such as shown in FIG. 3B. With reference to FIG. 3B, each cell of the data array 101 underlying the data array UI 102 can include multiple forms of data and the data can be changed by the user or affected by other cells.

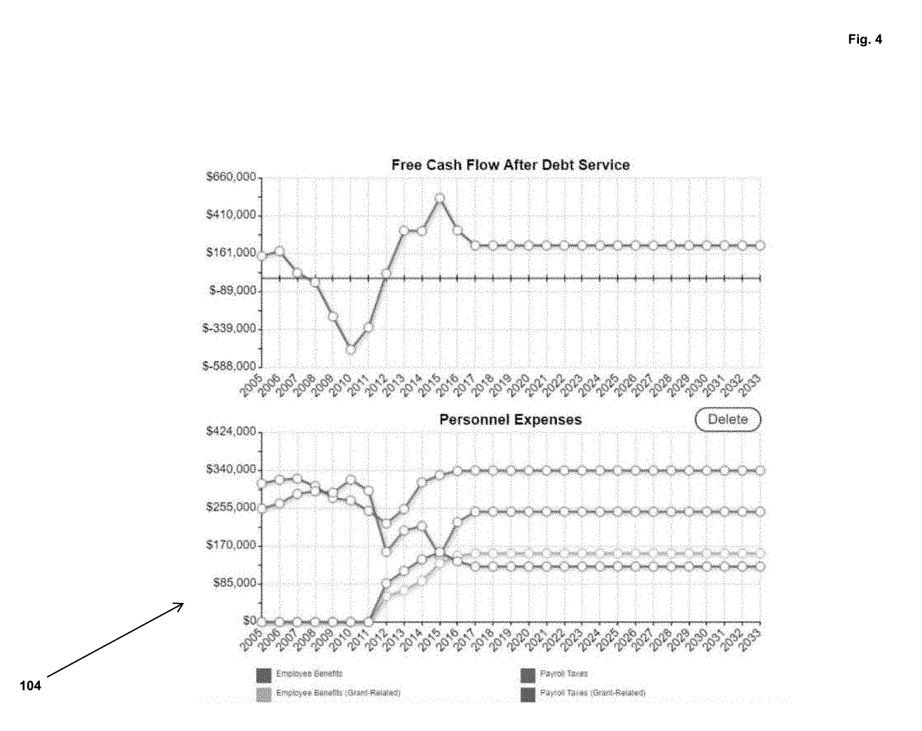

For a two-line graph of row X and row Y for columns a, b, and c, an array representing the graph can include: line 1 [xa value, xb value, xc value], line 2 [ya value, yb value, yc value], labels [a label, b label, c label]. This approach is scalable to accommodate any desired number of lines for incorporation in the graph (see FIG. 4).

During an initial load of the data array 101 or when the data array 101 changes, the graph UI 104 can be updated similar to process 2000 in any manner including the exemplary process 5000 for updating the data array 101 based on changes to the data array UI 102. With reference to FIG. 5, a user can select a particular data array 101 to load for display in the data array UI 102 (step 2001). Once loaded, the data array UI 102 can be edited (step 5002). At step 5003, the data calculator 105 receives the edited data from the underlying data array 101, which data calculator 105 processes the edits and applies the updates to relevant values of the data array 101. In some embodiments, the updates are stored in a temporary copy of the data array 101. At step 5004, the data calculator 105 updates the data array 101. At step 5005, the graph UI library 103 updates the data array UI 102 for presentation to the user. At step 5006, the data management system 100 presents a save dialog 801 (described below) to save the updated data array 101.

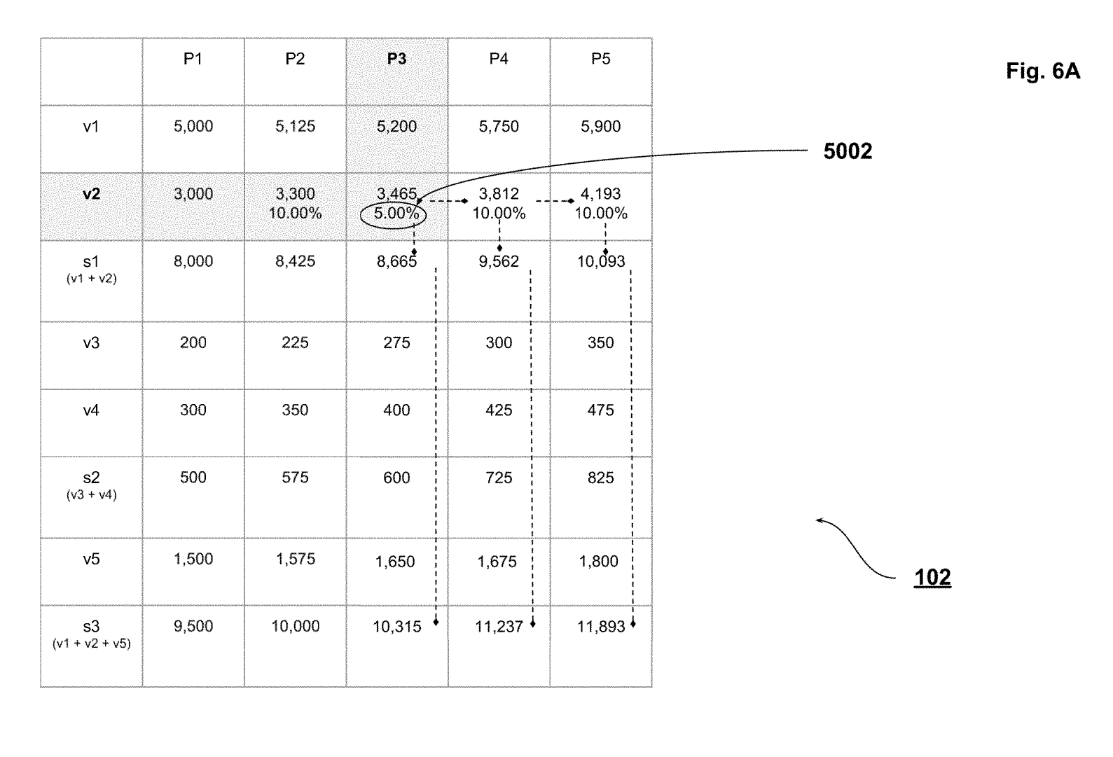

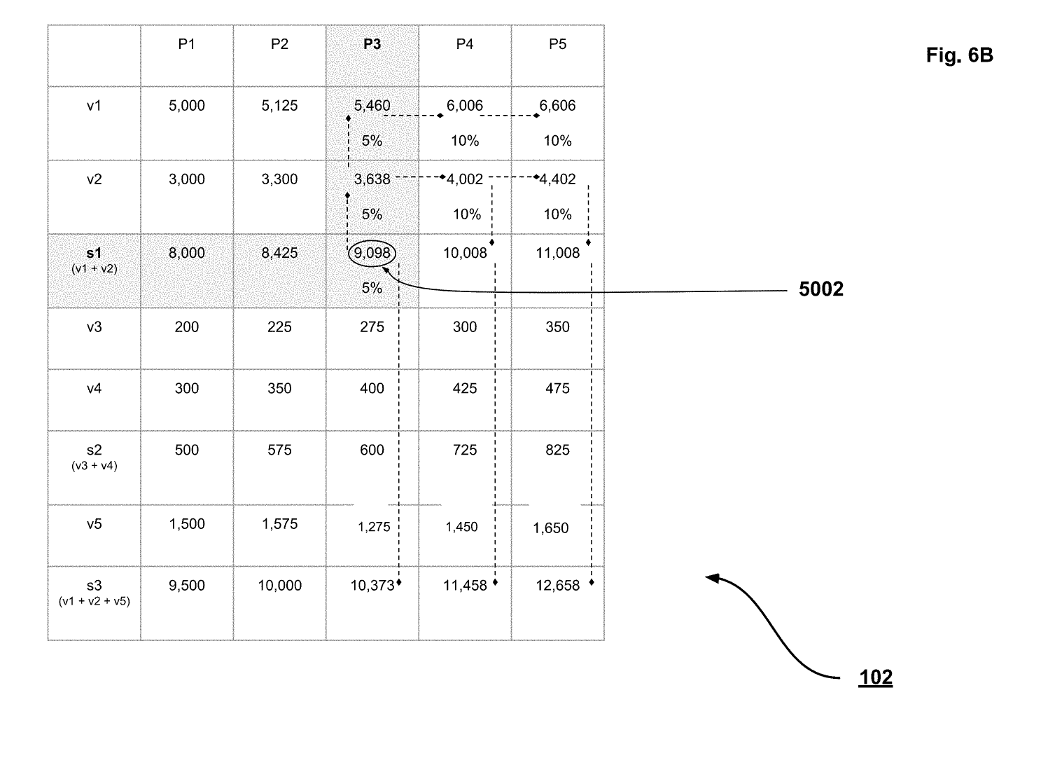

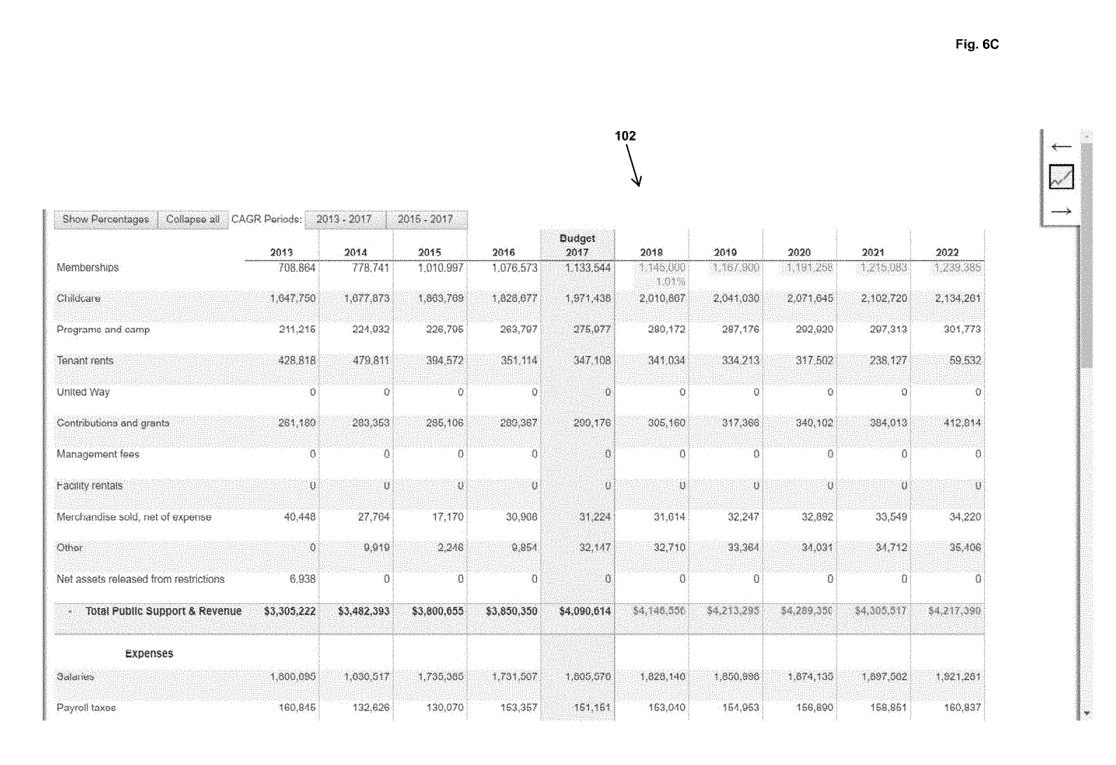

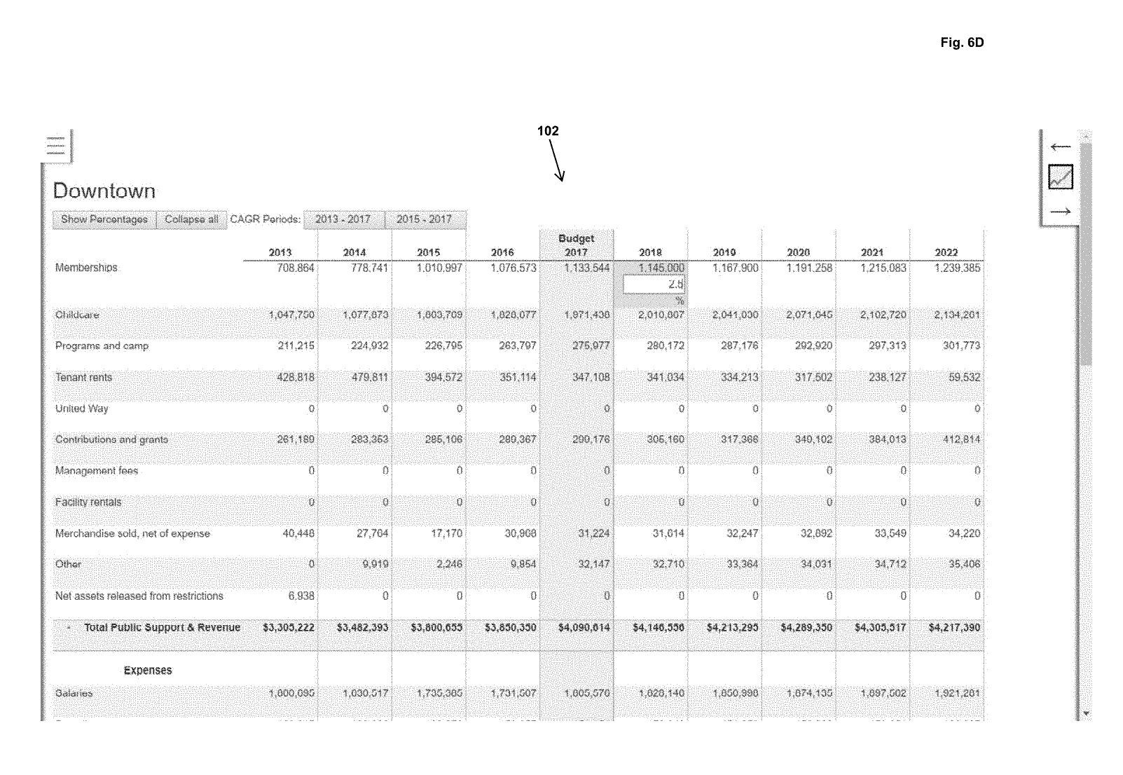

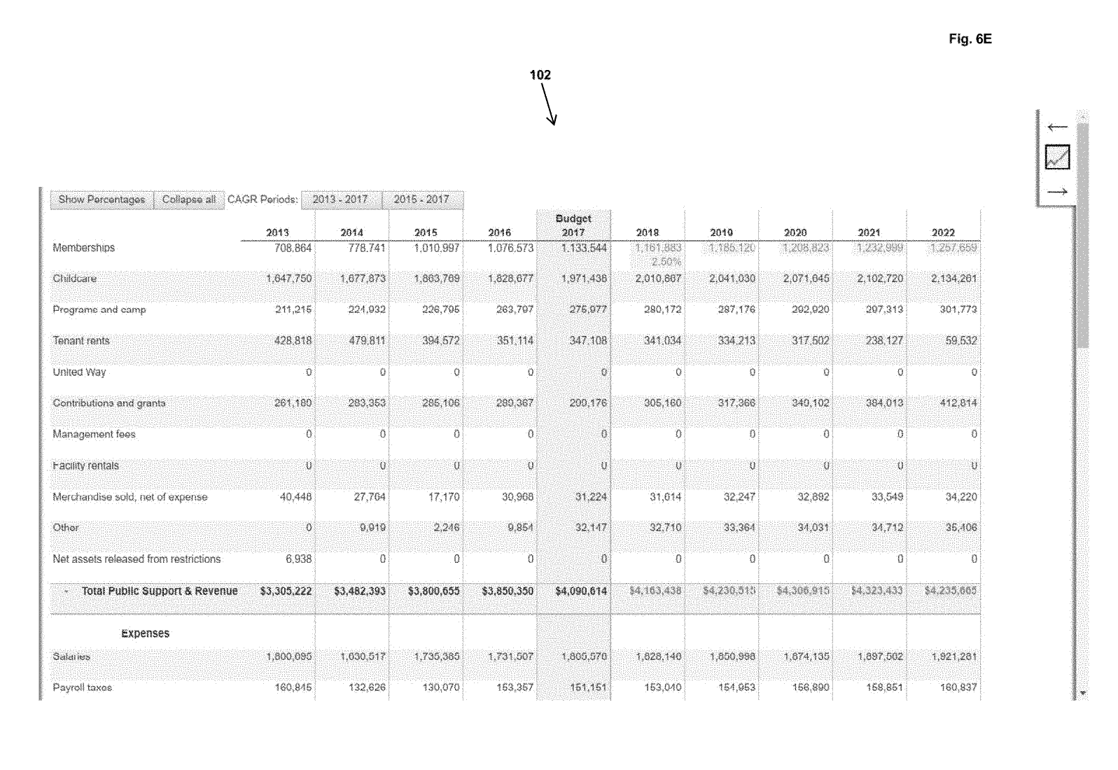

Turning to FIG. 6A, an exemplary data array UI 102 for updating a corresponding data array 101 using the process 5000 is shown. As shown, the data array UI 102 includes one or more value and sum lines. In this example, each horizontal cell contains an amount, or a percentage that denotes the change in amount between the current cell and the cell on the adjacent left. Although these values are shown for illustration only, one skilled in the art can appreciate any number of values and mathematical functions can be represented in the data array UI 102 and underlying data array 101. For example, the values and functions represented in the data array UI 102 can include amounts or calculations based on vertical cell relationships, horizontal cell relationships, and/or a combination of vertical and horizontal cell relationships. Those of ordinary skill in the art will also understand that amounts or calculations need not be based on cells that are immediately adjacent to one another or even viewable in the same data array UI 102 or graph UI 104.

In FIG. 6A, the data array 101 includes a two-dimensional object-oriented (e.g., JavaScript) structure that can be presented as the data array UI 102. A first dimension represents the row (referred to herein as the x-axis) and a second dimension of the structure represents the column of an array-based data structure (referred to herein as the y-axis). The object at the “intersection” of these two-dimensions includes user-facing information (e.g., amount and percentage) and metadata (not shown). Exemplary metadata includes keys referring to respective rows and columns in the data array 101, whether the cell data was originally loaded (at step 2001), and whether the cell has been modified (at step 5002).

In some embodiments, the data management system 100 maintains additional dimensional relationships among cells that are not immediately adjacent. For example, FIG. 6A depicts horizontal and vertical relationships among cells that are immediately adjacent (e.g., along line v2 in columns P3, P4, and P5) and cells separated by numerous lines (e.g., cells along line s3 in columns P3, P4, and P5).

FIG. 6A shows an edit to the percentage value in line v2, column P3 (step 5002) (i.e., edit from 10% to 5%) and the corresponding changes that are affected to line v2, s1, and s3, in columns P3, P4, and P5 (steps 5003 through 5005).

Turning to FIG. 6B, an example modification to a calculated value of the data array UI 102 is shown. In this example, the original amount in cell s1, P3 is $8,665. The data array UI 102 is modified from $8,665 to $9,068 (step 5002). The corresponding changes that are affected (steps 5003 through 5005) result in changes to lines v1 and v2 in columns P3, P4, and P5, as well as line s1 in column P4 and P5, and line s3 in columns P3, P4, and P5. Those values are prorated by the percentage change of the initial sum value to the new one. Depending upon user preferences and demands other methods of attributing the new sum (or other mathematical operation) cell values to the constituent value cells can be implemented.

Turning now to FIG. 6C, a direct edit (step 5002) to the percentage in the “Memberships” line associated with column “2018” is shown. Updating either the amount or the percentage cell for the row “Memberships” and column “2018” will change both the amount and percentage. Furthermore, in this example, row amounts to the right of the selected cell will also be updated by applying each respective cell's percentage change to the preceding cell's updated amount. In this example of the data array UI 102, user changes (step 5002) are processed by the data calculator 105 (step 5003) to update relevant data to the selected cell (step 5004) and any dependent cells, which updates the data array UI 102 at step 5005 (shown in FIG. 6D). In turn, as shown in FIG. 6E, each cell's relevant sum cells (e.g., “Total Public Support & Revenue” for “2018”, “2019”, “2020”, “2021”, and “2022”) are updated and highlighted. Stated in another way, one value change (e.g., row “Membership” and column “2018”) causes nine additional cells included in this data array 101 to be updated (e.g., rows “Memberships” and “Public Support & Revenue” and columns “2019” to “2022”). If a user shares edits (via a shared save 802 discussed below)—whether edits were made via graph UI 104 (step 2013) or via data array 102 (step 5006), cells in related compilations of data arrays will also be updated.

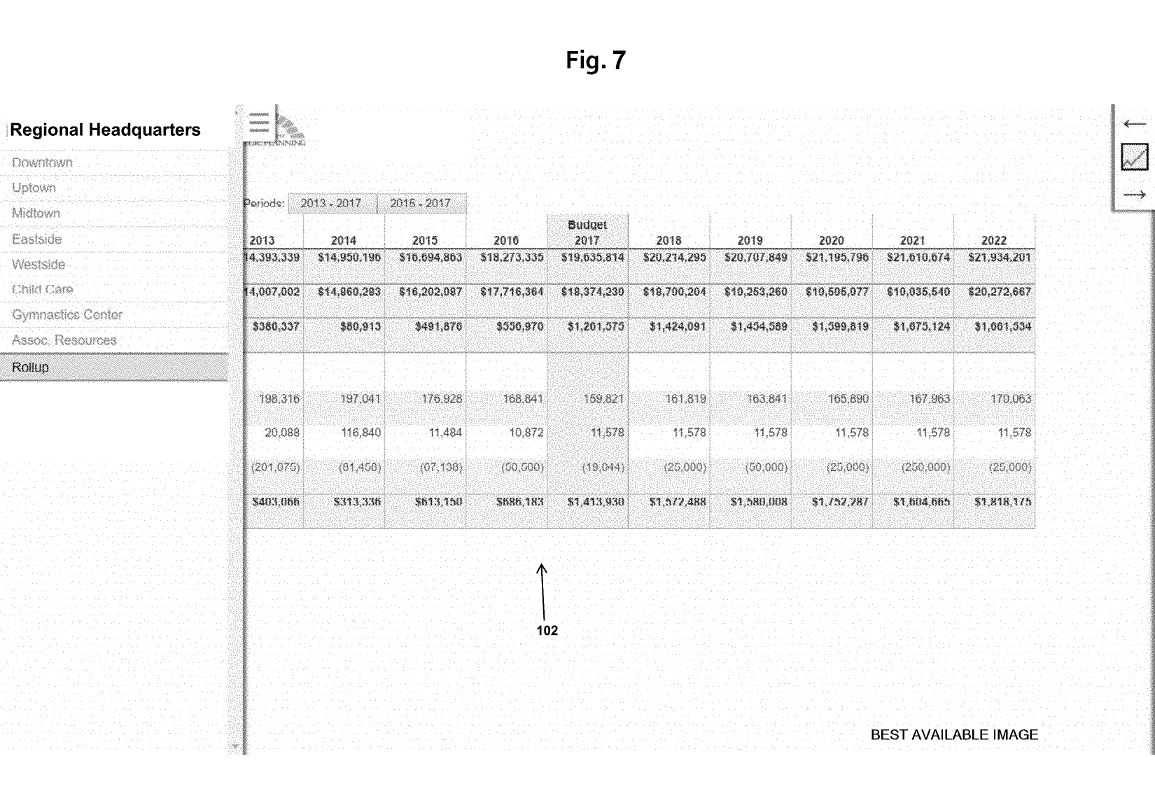

Turning to FIG. 7, one embodiment of the data array UI 102 is shown. As illustrated, additional features of the data array 101 (e.g., named “Regional Headquarters”) and features in related data arrays (e.g., ‘business units’ named “Downtown”, “Uptown”, “Midtown”, “Eastside”, “Westside”, “Child Care”, “Gymnastics Center”, “Assoc. Resources”, and “Rollup”) are presented to the data array UI 102. These related business units can be selected by ‘clicking’ on a desired name of the selected data array 101 (step 2001), which loads the graph UI 104 (step 2001) and the corresponding data Array UI. The relationships among the data array 101 business units and regional headquarters enable a user to access views of, change, and analyze relationships in the related business units and the regional headquarters through the graph UI 104 and the data array UI 102 for any number of desired constructs.

In this example shown in FIG. 7, the “rollup” of the data array 101 includes a compilation of the other business units that aggregates the data array 101 values from each of the other business units. A multi-dimensional editing capability associated with the graph UI 104 and the data array UI 102 can be executed “bottom-up” by changing values at of a single business unit or “top-down” by editing values in the “rollup”.

The “bottom-up” approach to changing values associated with single business units to affect the “rollup” compilation follows the same system process of changing values in the graph UI 104 and the data array UI 102 that are described with reference to process 2000 and 5000.

Likewise, the “top-down” approach to modifying data in a “rollup” changes values in related business units by following the same system methodology as changing values with the graph UI 104 and data array UI 102 that are described above in process 2000 and process 5000, respectively. In one embodiment, edits to the “rollup” data array 101 made through the “top-down” approach processes and applies updated calculations through the data calculator 105 across each related business unit. Depending upon user preferences and demands, the distribution of the updated “rollup” calculations to business units can be configured to processes and apply data to single data arrays based on any number of mathematical operations (e.g., pro rata, weighted to a value factor, etc.).

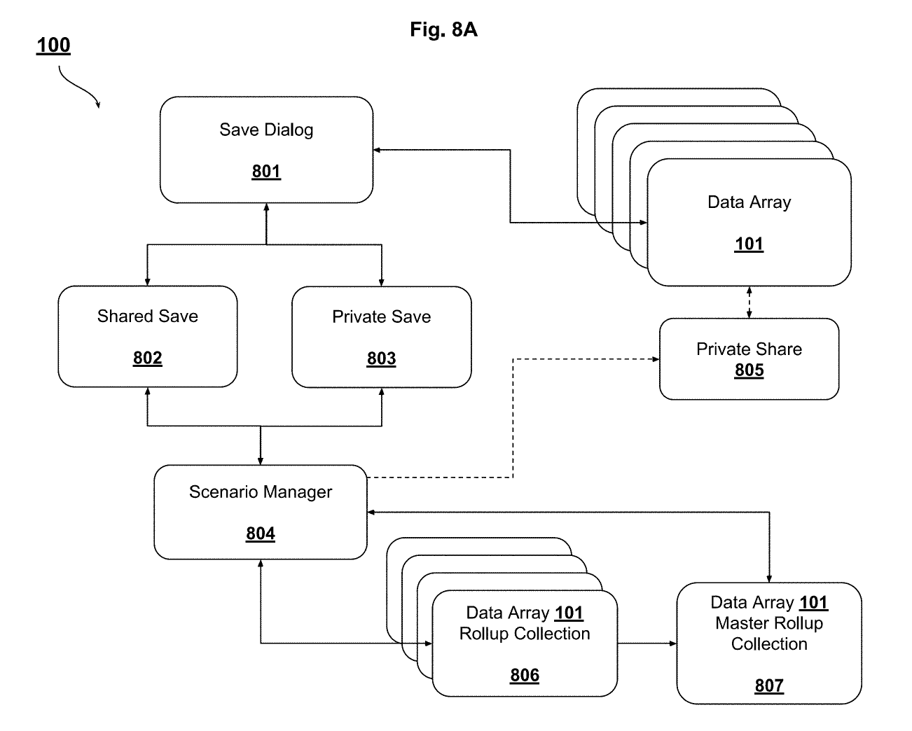

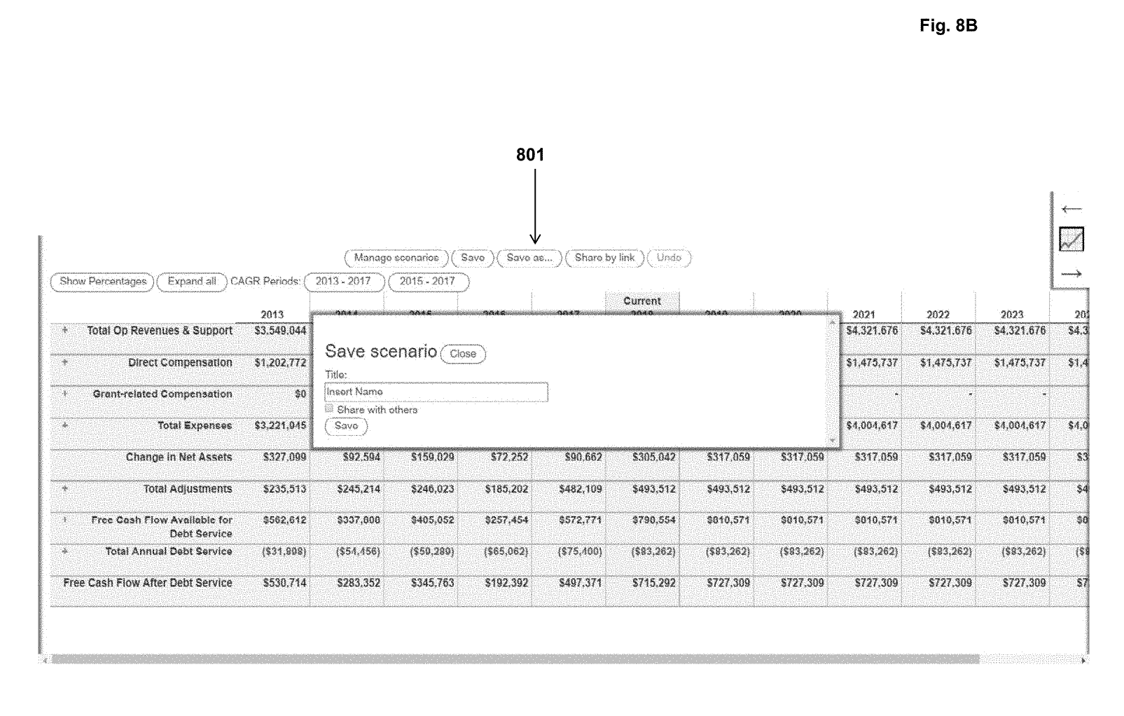

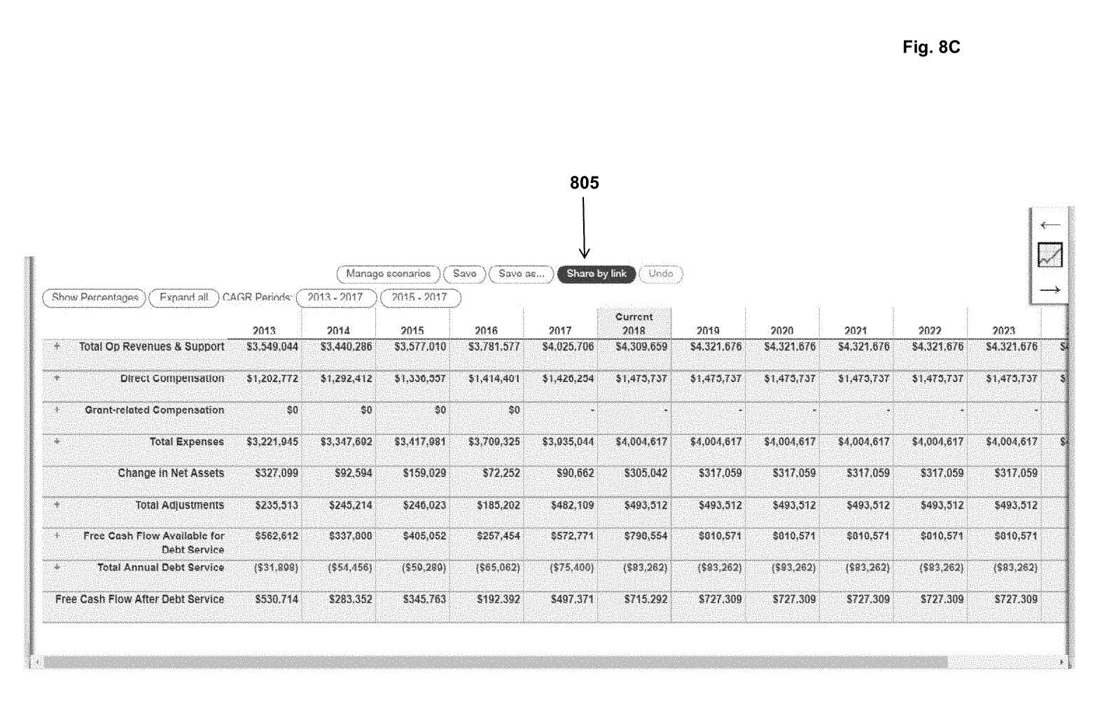

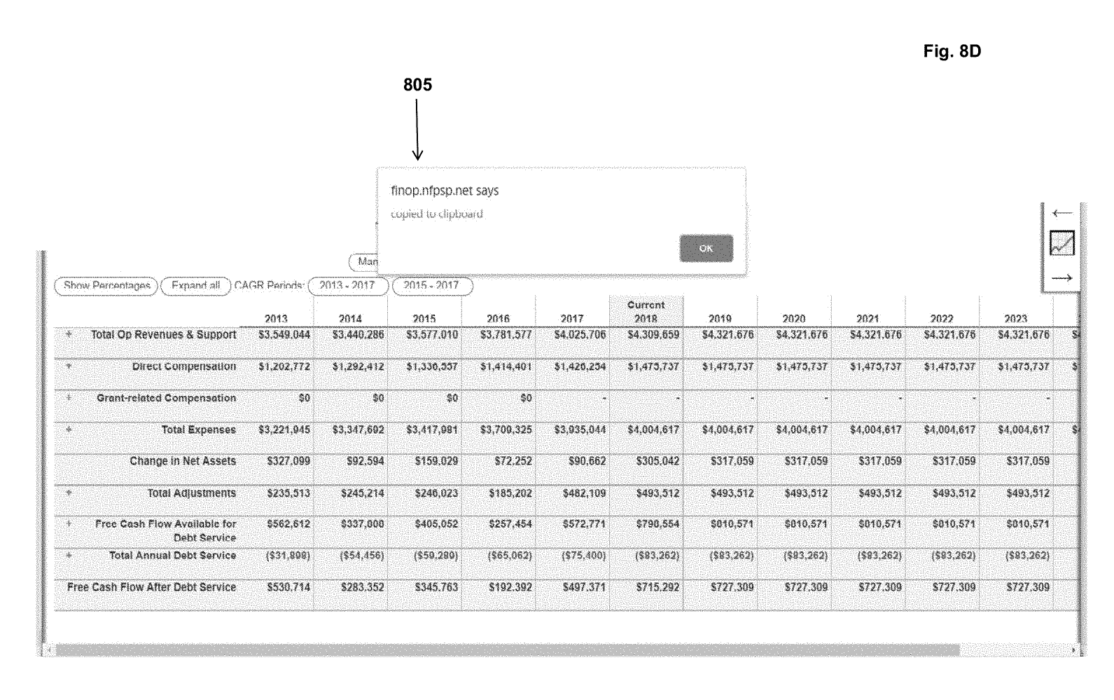

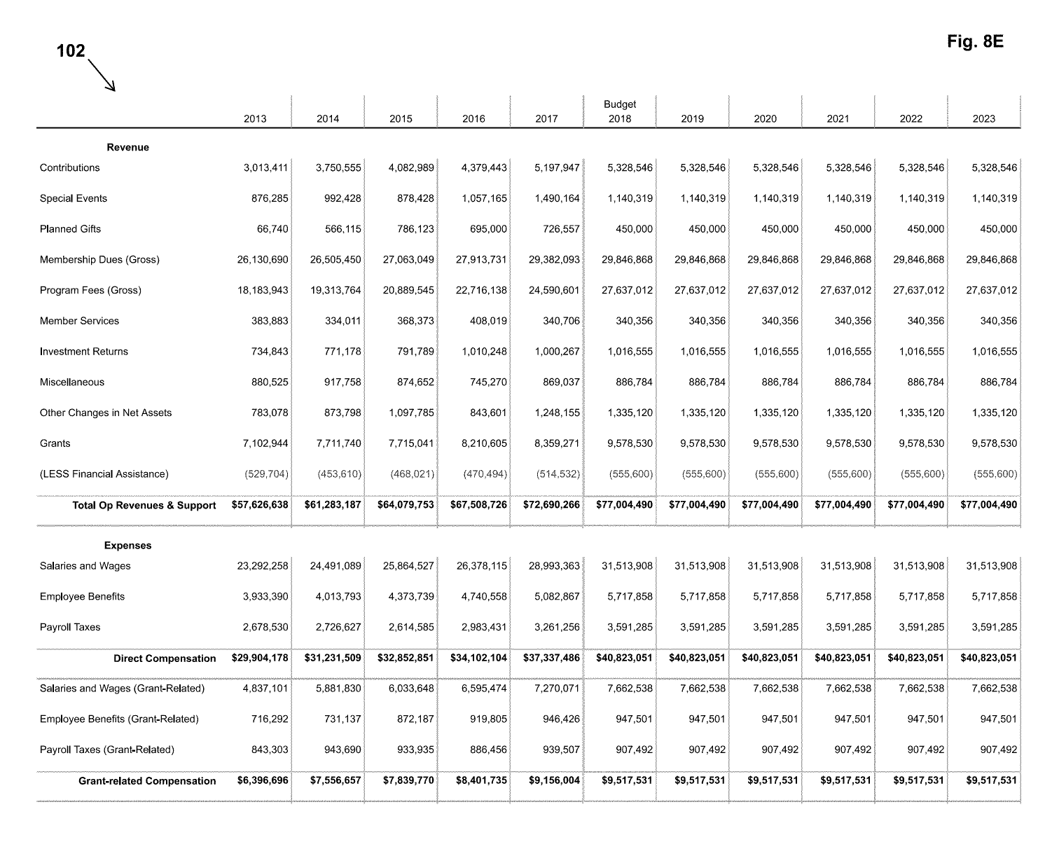

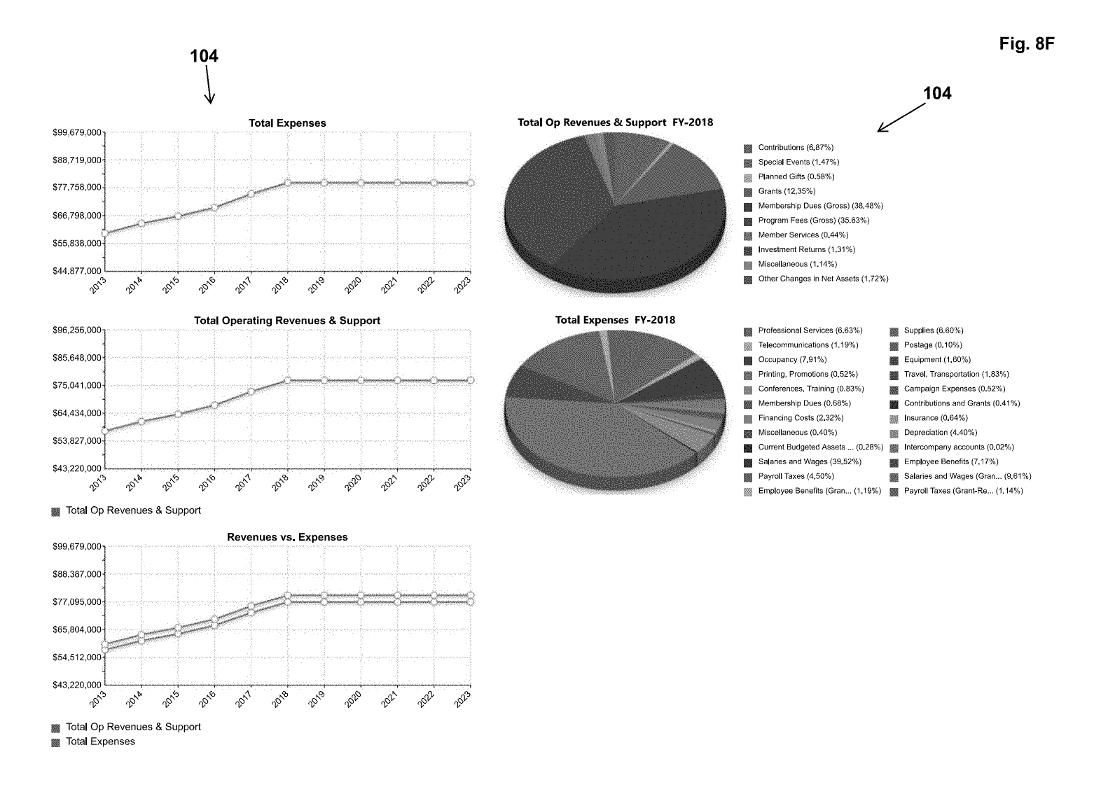

The data management system 100 advantageously enables users to save, retrieve, and share scenarios, thereby fostering collaboration among different users of the data management system 100. Users can manage and access multiple data arrays and graphs created by multiple users, such as shown in FIG. 8A. Turning to FIG. 8A, an alternative embodiment of the data management system 100 includes a scenario manager 804 for enabling a save dialog 801, a shared save option 802, a private save 803, and a private share 805. Additionally and/or alternatively, the scenario manager 804 advantageously enables users to group related data arrays 101 into one or more collections 806 of data arrays 101. Among the collection 806 of data arrays 101, a selected collection 806 can be marked as a preferred (or master rollup collection 807).

The save dialog 801 can be loaded by selecting and clicking ‘Save as . . . ” on the data array UI 102, as shown in FIG. 8B. The save dialog 801 presents a text input object for naming the data array 101 in free text, saving the edited data array 101 as a ‘scenario’ either for the private use of the user that created the scenario, or sharing the selected data array 101 with other users by using the private share 805 (shown in FIG. 8C) or selecting the box “Share with others” (shown in FIG. 8B). The “Share with others” selection creates a saved copy of the data array 101 and graph UI 104 to be available to all other users having permission to display or change the relevant data array 101. The method of saving or sharing with other users, the ‘pop-up’, use of free text, and other related elements can include any desired user selections and steps for identifying, saving, and sharing a scenario.

In some embodiments, the data management system 100 can provide a private share 805, such as a “Share by link” (shown in FIG. 8C), to share a copy of the relevant data array 101 with only select (self-determined) users with permission to display the specified data array. The data management system 100 automatically copies the address (e.g., a uniform resource locator (URL)) of the referenced data array 101 to the user's local device by selecting and clicking “OK” in the ‘popup’ (in this example, shown as “finop.nfpsp.net says” in FIG. 8D) and pasting the URL into an e-mail, text message or other method of communicating such information. The method of privately sharing with other users, the ‘pop-up’, use of free text and other related elements can include other desired user selections and steps for privately sharing a scenario.

In some embodiments, one or more versions of the data array 101 can be shared by printing the data array UI 102 and graph UI 104 (shown in FIG. 8E and 8F). Referring to FIG. 8E and FIG. 8F, the data management system 100 configures and formats the data array 101 to print to portable document format, paper, etc. Advantageously, recipients of the printed copies of the data array 101 cannot modify the original data array 101 from which the printed version is based. The formatting of printed scenarios (FIG. 8E and FIG. 8F) can include any desired user configuration of pagination, page margins, dates and times, the identity of the user that created the scenario, default text, default pictures, and/or other embedded elements to be printed.

The scenario manager 804, advantageously provides multiple users with the ability analyze, share, collaborate, and directly test changes to any shared data array 101.

For example, FIG. 9A illustrates an exemplary process 9000 for managing multiple user created and shared versions of the data array 100. In one embodiment, user collaboration on data management system 100 is accessible through the data array UI 102 by selecting and clicking ‘manage scenarios’ to load the scenario manager 804 (shown in FIG. 9B). In step 9001, a private shared data array 101 or scenario manager 804 is loaded.

If the scenario manager 804 is used, any version of the data array 101 that has been shared by another user (“Other's shared scenarios”) or created by the user loading the scenario manager 804 (“My scenarios”) can be loaded (such as shown in FIG. 9B). In step 9002, the data management system 100 allows a permissioned user to select specific shared versions of related data arrays 101 and to include multiple business units to create the “rollup” described above. Once the rollup has been created in (step 9002), a “top down” edit occurs via process 2000 or 5000 as described above.

At step 9003, all related data arrays 100 that have been edited are marked as “modified” as a result of the “top down” edit, and all relevant values can be highlighted as described above. At step 9004, a “Rollup” can be marked as the “master” to indicate that this group of related data arrays 101 is preferred to any others that may be listed in the scenario manager 804 (shown in FIG. 9E). At step 9005, each corresponding data array 101 that has been included in the “master Rollup” can be tagged as a “Master Scenario”. As shown in FIG. 9C, selecting and clicking “manage scenarios” causes a ‘pop-up’ screen to be displayed that includes a list of “My scenario” and “Other's shared scenarios” versions (e.g., data array version “Ed's 2019 Contribution Idea”). The lists of ‘My scenarios’ and ‘other's shared scenarios’ can comprehensively include every data array created by a user (whether shared with others or not) and those shared by other users. Each of the data array 100 scenarios that has been created in ‘My scenarios’ can be displayed through the graph UI 104 and the data array UI 102 by clicking the ‘Load’ icon (step 2001), or deleted by clicking the ‘Delete’ icon (FIG. 9C).

Referring to FIG. 9C, each of the data array 101 scenarios that have been shared by the user are indicated by a ‘check’ icon in the scenario manager 804. This advantageously provides the user with an ability to find, display, analyze, change, share and delete scenarios they have previously created.

Similarly, as shown in FIG. 9D the Scenario Manager 804 displays each of the data array 101 scenarios that have been created and shared by other users (e.g., ‘Other's shared scenarios’) and that can be accessed by a permissioned user, and displayed or modified (e.g., processes 2000 and 5000). The tooltips, icons, or other means of choosing a scenario to load, delete, indicating which scenario has been chosen, and which scenarios have been shared can take other desirable forms. This advantageously provides the user with an ability to find, display, analyze, change and share scenarios created and shared by other users on a common platform.

FIG. 9D is one example of another user (e.g., from ‘other's shared scenarios’) who created, shared and saved the “Dave's Membership Ideas” scenario in the Data Array 101 group named “North”, and has recommended that data array be included into the a “master rollup” (the collection 807 of data arrays 101). Users can select and identify which scenario to recommend (via the scenario manager 804) by clicking on the ‘pointed finger’ icon 901 (shown in FIG. 9C) adjacent to the recommended scenario. Once a scenario is selected for recommendation by clicking the ‘pointer finger’ icon 901, a tooltip notification of the action appears (see FIG. 9C) and the ‘pointer finger’ icon 901 changes its color as a means of identifying the selected scenario (FIG. 9C). The tooltips, icons or other means of choosing a scenario to recommend can take other desirable forms.

FIG. 9D is one embodiment of a “master rollup” named “All business units” (i.e., the master rollup collection 807) where the ‘pop-up’ “master Rollup scenario collections” displays a user recommendation of from FIG. 9C (the “Dave's Membership Ideas” scenario) in the data array 101 named “North”. In this example a tooltip describing that the scenario has been recommended is displayed within the popup shown in FIG. 9D. A permissioned user may select, load and view the recommended data array, or any other shared data array appearing as shared in the scenario manager 804. The embodiment shown in FIG. 9D advantageously enables collaboration among permissioned users. The tooltips, icons or other means of identifying a scenario that has been recommended can take other desirable forms.

FIG. 9E illustrates another exemplary embodiment of a “master rollup” named “All business units” (FIG. 807) where the scenario manager 804 displays a list of the “Master Rollup scenario collections” that have been created and can be displayed through the graph array UI 104 and the data array UI 102 by clicking the ‘Load’ icon (at step 2001) (in this example the “Master rollup” scenario named “Close lease and Grow by 2%” (shown in FIG. 9E).

In this example the ‘pop-up’ “Master rollup scenario collections” also displays a list of the data array 101 scenarios for each “Business unit” created, saved and shared by “Other users”. Each of these “Other user's scenarios” can also be displayed through the graph array UI 104 and the data array UI 102 by clicking the ‘Load’ icon (at step 2001) adjacent to the “Business unit”. The lists of “Business units” listed in Scenario Manager 804 can comprehensively include every data array 101 created and shared by related, permissioned users of the data management system 100, and the icons and arrangement of methods to select a scenario can be created to suit user preferences and requirements.

In step 9002, the scenario manager 804 can filter “Business unit scenarios” (e.g., “Overnight Camp”, “Insurance Increase in 2019 and 2020”) by clicking the “Load” icon (shown in FIG. 9E). At step 9004, the selected data array 101 scenario can be included in the “All business units” rollup. At step 9002, the data management system 100 combines the selected data array 101 with each of the other related data array 101 scenarios included in Master Rollup Collection 807. A user may select and load any combination of shared related Data Array 101 scenarios to be included in the “rollup” Data Array 101 at step 9002.

In one embodiment, a user can identify one of the “Rollup scenario collections “as the “Master rollup” 807 (at step 9004) by selecting the ‘finger pointer’ icon associated with the chosen rollup scenario collection. In this example, a tooltip notification and a change in color of the ‘pointer finger’ icon is displayed on the scenario manager 804 to indicate which of the “Rollup scenario collections” has been identified as the Master rollup collection 807). The master rollup collection. 807 can then be loaded through the scenario manager 804 and displayed through the data array UI 102 and the graph UI 104 by clicking the ‘Load’ icon in the scenario manager 804. The tooltip, icon or other means of notifying users which “Rollup scenario collection” has been recommended can take other desirable forms.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for graph data management and array updates, the method comprising:
loading one or more data arrays, each data array comprising a structured data model;
presenting at least one data array from the one or more data arrays as a graph user interface;
transforming the structured data model into a format readable by a graph user interface library;
applying the transformed structured data model to the graph user interface library;
receiving updates to the presented data array, said updates received from the graph user interface and representing at least one graph point as a coordinate pair corresponding to a cell of the at least one data array;
converting the received updates via the graph user interface library from the coordinate pair to a graph format;
updating the graph user interface based on the converted graph format; and
applying converted updates to the at least one data array based on the update to the graph point.

2. The computer-implemented method of claim 1, wherein said structured data model is structured as an object-oriented dictionary object.

3. The computer-implemented method of claim 2, wherein said structured data model is represented by a key-value pair.

4. The computer-implemented method of claim 3, wherein the key of each pair represents an identifier for a selected value or a calculation line, and the value of each pair references a second dictionary object having a second key of the respective data array.

5. The computer-implemented method of claim 4, wherein the second key represents at least one of an amount field, a calculated field, a modified tag, and a futures workspace field.

6. The computer-implemented method of claim 1, wherein said transforming the structured data model comprises representing the structured data model as a point object of the graph user interface library.

7. The computer-implemented method of claim 1, wherein said presenting the at least one data array as a graph user interface further comprises presenting one or more tooltips, and wherein said receiving updates from the graph user interface comprises dynamically displaying the updates as the one or more tooltips.

8. The computer-implemented method of claim 1, further comprising saving the updated at least one data array to a database.

9. The computer-implemented method of claim 1, further comprising sharing the updated at least one data array using a hyperlink.

10. A computer-implemented method for graph data management and array updates, the method comprising:
loading one or more data arrays, each data array comprising a structured data model;
presenting at least one data array from the one or more data arrays as a data array user interface;
receiving updates to the presented data array, said updates received from the data array user interface and corresponding to a cell of the at least one data array;
updating the at least one data array based on the received updates; and
updating the graph user interface based on the received updates.

11. The computer-implemented method of claim 10, wherein said structured data model is structured as an object-oriented dictionary object.

12. The computer-implemented method of claim 11, wherein said structured data model is represented by a key-value pair.

13. The computer-implemented method of claim 12, wherein the key of each pair represents an identifier for a selected value or a calculation line, and the value of each pair references a second dictionary object having a second key of the respective data array.

14. The computer-implemented method of claim 13, wherein the second key represents at least one of an amount field, a calculated field, a modified tag, and a futures workspace field.

15. The computer-implemented method of claim 10, further comprising saving the updated at least one data array to a database.

16. The computer-implemented method of claim 10, further comprising sharing the updated at least one data array using a hyperlink.

17. A system for graph data management and array updates, the system comprising:
one or more data arrays, each data array comprising a structured data model;
a graph user interface for presenting at least one data array from the one or more data arrays;
a data array user interface for presenting the at least one data array from the one or more data arrays;
a graph user interface library in operable communication with the one or more data arrays and the graph user interface; and
a data calculator for transforming the structured data model into a format readable by the graph user interface library,
wherein said data calculator further applies the transformed structured data model to the graph user interface library, receives updates to the presented data array, said updates received from the graph user interface and representing at least one graph point as a coordinate pair corresponding to a cell of the at least one data array, converts the received updates via the graph user interface library from the coordinate pair to a graph format, and updates the graph user interface and the at least one data array based on the converted graph format.

18. The system of claim 17, wherein said structured data model is structured as an object-oriented dictionary object.

19. The system of claim 17, wherein said graph user interface library includes a JavaScript library.

20. The system of claim 17, further comprising a scenario manager for naming the at least one data array, saving the at least one data array, or sharing the at least one data array.
